(19) United States
(12) Patent Application Publication
(10) Pub. No.: US 2024/0409706 A1
(43) Pub. Date: Dec. 12, 2024

(54) POLYMER PROCESSING SYSTEMS AND METHODS EMPLOYING PULSED HEATING

(71) Applicants: UNIVERSITY OF MARYLAND, COLLEGE PARK, College Park, MD (US); THE TRUSTEES OF PRINCETON UNIVERSITY, Princeton, NJ (US)

(72) Inventors: Liangbing HU, Rockville, MD (US); Dongxia LIU, Clarksville, MD (US); Qi DONG, Newton, MA (US); Sichao CHENG, Henderson, NV (US); Yiguang JU, Princeton, NJ (US)

(21) Appl. No.: 18/698,180

(22) PCT Filed: Oct. 4, 2022
(86) PCT No.: PCT/US2022/045656

§ 371 Date: Apr. 3, 2024

Related U.S. Application Data
(60) Provisional application No. 63/362,660, filed on Apr. 7, 2022.
(60) Provisional application No. 63/262,088, filed on Oct. 4, 2021.

(51) Int. Cl. C08J 11/12; B01J 6/00

(52) U.S. Cl. CPC C08J 11/12; B01J 6/008; C08J 2301/02; C08J 2305/08; C08J 2321/00; C08J 2393/04; C08J 2397/00

(57) ABSTRACT

A reactant comprising one or more polymers can be subjected to multiple consecutive processing cycles. Each processing cycle can have a first period with heating applied and a second period immediately following the first period with no heating applied. A duration of each processing cycle can be less than or equal to 10 seconds, and a duration of each first period can be less than 1 second. The subjecting can be effective to convert at least some of the reactant into one or more products, for example, one or more constituent monomers or other volatile or gas-phase species. In some embodiments, a reactor can be provided between a heating source and the reactant, for example, to provide a spatio-temporal temperature profile for improved polymer processing.

### CROSS-REFERENCE TO RELATED APPLICATION

The present application claims the benefit of U.S. Provisional Application No. 63/262,088, filed Oct. 4, 2021, entitled “High Temperature, Pulsed Heating Reactor and Methods for Polymer Recycling.” and U.S. Provisional Application No. 63/362,660, filed Apr. 7, 2022, entitled “System, Device, and Method for Selective Depolymerization,” each of which is incorporated by reference herein in its entirety.

### FIELD

The present disclosure relates generally to polymer processing, and more particularly, to polymer processing (e.g., depolymerization) via heating, for example, by subjecting a reactant to short duration pulses of high temperature.

### BACKGROUND

Common but highly unsustainable methods of removing plastic waste include burning or burying it underground, with the former being extremely carbon-heavy and air-polluting while the latter can create long-term damage to the environment. Alternatively, many thermoplastics can be recycled through mechanical processing (e.g., by grinding, compounding, etc.) into low-end but somewhat useful materials. However, the limited product value and energy-intensive process make this approach economically unattractive. Thermochemical plastic decomposition has been investigated for converting plastic waste into value-added chemicals. Among the numerous thermochemical plastic decomposition pathways, depolymerization holds great economic incentive as the generated monomers can be reused in subsequent polymerization reactions for another product lifecycle.

Although a few plastics can be readily depolymerized (e.g., poly(methyl methacrylate) and polystyrene) via conventional thermochemical treatment under near-equilibrium conditions, other plastics (e.g., most polyolefins and polyesters) cannot be converted to their monomers with high selectivity. This low selectivity is due to the competition between depolymerization (C—C or C—O bond breaking between monomer units), random chain scission (other C—C or C—O bonds breaking), dehydrogenation (C—H bond breaking), and aromatization pathways (C—C coupling) during continuous heating of the plastic at constant temperature under near-equilibrium conditions, which leads to a range of products (e.g., light hydrocarbons, aromatics, soot, coke, etc.) beyond the monomer. To address this problem, conventional processes often use catalysts, which only improve the product selectivity marginally but are prone to degradation due to coking. For example, the pyrolysis of polypropylene (PP) typically exhibits a monomer yield of just ˜10% without catalysts and <25% using optimized catalysts. In another example, the pyrolysis of poly(ethylene terephthalate) (PET) often leads to various aromatic species, with <25% yield to the 1,4-benzenedicarboxylic acid monomer.

Embodiments of the disclosed subject matter may address one or more of the above-noted problems and disadvantages, among other things.

### SUMMARY

Embodiments of the disclosed subject matter system provide systems and methods for processing of polymers, for example, to recycle and/or convert polymers into smaller constituent molecules (e.g., having a smaller carbon number), such as but not limited to monomers. In some embodiments, pulsed heating can be used to selectively convert polymers into constituent molecules in a catalyst-free and far-from-equilibrium process. In some embodiments, the processing of the polymers involves a spatial temperature gradient. In some embodiments, the spatial temperature gradient can be produced at least in part by the use of a reactor interposed between the polymer and the pulsed heating source. For example, spatial temperature gradient can induce a process of melting, wicking, and reaction of the plastic. Meanwhile, the transient heating pulse (e.g., <1 s in duration) can offer enough time for the weakest bonds that connect molecular fragments (e.g., monomers) to break, while simultaneously suppressing undesired pathways toward side products (e.g., aromatics, coke, soot, etc.) that have longer reaction timescales. In some embodiments, the combination of spatial temperature gradient and transient heating can produce spatio-temporal heating that offers enhanced processing of polymers, for example, with a monomer conversion yield in excess of 25% (e.g., 30-60%).

In one or more embodiments, a method can comprise subjecting a reactant to multiple consecutive processing cycles. Each processing cycle can comprise a first period with heating applied and a second period immediately following the first period with no heating applied. A duration of each processing cycle can be less than or equal to 10 seconds, and a duration of each first period can be less than 1 second. The reactant can comprise one or more polymers. At least a first end of a reactor can be disposed in contact with the reactant prior to the subjecting. The reactor can comprise a plurality of pores, a plurality of microchannels, or both. The subjecting can such that a temperature gradient is induced across a thickness of the reactor. During the subjecting, melted reactant can be transported into the reactor via capillary action. The subjecting can be effective to convert at least some of the reactant into one or more first products.

In one or more embodiments, a reactant processing system can comprise a reactor, a heating system, and a controller. The reactor can comprise a plurality of pores, a plurality of microchannels, or both. The heating system can be configured to heat at least the reactor. The controller can be operatively coupled to the heating system. The controller can comprise one or more processors and computer-readable storage media storing instructions that, when executed by the one or more processors, cause the controller to control the heating system to subject the reactant to multiple consecutive processing cycles. Each processing cycle can comprise a first period with heating applied and a second period immediately following the first period with no heating applied. A duration of each processing cycle can be less than or equal to 10 seconds, and a duration of each first period can be less than 1 second. The reactor can be constructed to transport melted reactant at a first end of the reactor into the reactor via capillary action. One or more of the processing cycles can be effective to convert at least some of the reactant into one or more first products at a second end of the reactor opposite the first end.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1A is a process flow diagram of a generalized method for processing of a reactant, according to one or more embodiments of the disclosed subject matter.

FIG. 1B depicts aspects of a non-continuous or discontinuous heating profile that can be employed for reactant processing, according to one or more embodiments of the disclosed subject matter.

FIG. 1C depicts a pulse heating profile that can be employed for reactant processing, according to one or more embodiments of the disclosed subject matter.

FIGS. 2A-2B are simplified schematic diagrams of a reactant processing setup during heating and quench periods, respectively, according to one or more embodiments of the disclosed subject matter.

FIG. 3A illustrating operation of a reactant processing setup, according to one or more embodiments of the disclosed subject matter.

FIG. 3B is a simplified schematic diagram of a generalized system for processing of polymers, according to one or more embodiments of the disclosed subject matter.

FIG. 3C is a simplified illustration of an exemplary plastic recycling system, according to one or more embodiments of the disclosed subject matter.

FIG. 4A is a simplified schematic diagram of a reactant processing setup employing a Joule heating element and a reactor, according to one or more embodiments of the disclosed subject matter.

FIG. 4B is a simplified schematic diagram illustrating operation of the reactant processing setup of FIG. 4A, according to one or more embodiments of the disclosed subject matter.

FIGS. 5A-5H are simplified schematic diagrams of various reactant processing setups, according to one or more embodiments of the disclosed subject matter.

FIG. 6 is a simplified schematic diagram of another reactant processing setup, according to one or more embodiments of the disclosed subject matter.

FIG. 7A illustrates a setup including a polymer-infiltrated heating element for reactant processing, according to one or more embodiments of the disclosed subject matter.

FIG. 7B illustrates another setup including a polymer-infiltrated heating element for reactant processing, according to one or more embodiments of the disclosed subject matter.

FIG. 8 is a simplified schematic diagram depicting a generalized example of a computing environment in which the disclosed technologies may be implemented.

FIG. 9A shows locations in a cross-sectional view of a depolymerization setup where temperature measurements were obtained during operation.

FIG. 9B is a graph of measured temperature versus time for a single processing cycle at the locations of FIG. 9A for depolymerization of polypropylene (PP).

FIG. 9C shows a location in a cross-sectional view of a depolymerization setup where scanning electron microscopy (SEM) images were obtained after various stages of operation.

FIG. 9D is an SEM image of the location of FIG. 9C prior to any depolymerization processing.

FIGS. 9E-9F are SEM images of the location of FIG. 9C after multiple processing cycles but prior to exhaustion of the polymer supply.

FIG. 9G is an SEM image of the location of FIG. 9C after multiple processing cycles have exhausted the polymer supply.

FIG. 10A compares monomer (C₃H₆) yields for depolymerization of PP performed via constant heating or pulsed heating with different ratios of heating period to quench period, where the error bars denote standard deviation with n≥3.

FIG. 10B compares monomer yields for depolymerization of PP performed via constant heating or pulsed heating with different processing cycle durations at a fixed ratio (1:9) of heating period to quench period, where the error bars denote standard deviation with n≥3.

FIG. 10C is graph of monomer production over time for depolymerization of PP at a processing cycle duration of 1.10 seconds and a heating period of 0.11 seconds, where the error bars denote standard deviation with n≥3.

FIG. 11A illustrate reactive molecular dynamics simulations of PP pyrolysis at 2727° C. at various time stages.

FIG. 11B is a graph of C₃H₆ and H₂ molecule counts throughout the simulated reaction timeframe.

FIG. 11C is graph of various carbon fractions in the simulations as a function of pyrolysis reaction time.

FIG. 12 is a graph of measured temperature versus time for a single processing cycle at the locations of FIG. 9A for depolymerization of polyethylene terephthalate (PET).

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about” is recited. Whenever “substantially.” “approximately.” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following is provided to facilitate the description of various aspects of the disclosed subject matter and to guide those skilled in the art in the practice of the disclosed subject matter.
Reactor: One or more layers disposed between a heating source (e.g., a Joule heating element) and a reactant that facilitates processing of the reactant via depolymerization. In some embodiments, the reactor is porous and/or has microchannels therein, such that liquid reactant can be infiltrated into the reactor via capillary action. In some embodiments, heating (e.g., transient heating) of the reactor can induce a time-varying temperature gradient therein (e.g., spatio-temporal temperature gradient), where a temperature at one end of the reactor oscillates between a first temperature greater than a decomposition temperature of the reactant and a second temperature less than a decomposition temperature of the reactant. In some embodiments, the spatio-temporal temperature gradient is such that a temperature at an end of the reactor contacting the reactant is maintained greater than a melting temperature of the reactant.
Microchannel: An engineered channel formed in a solid layer or structure and having a maximum diameter less than 1 mm. In some embodiments, the microchannel can extend substantially parallel to and/or through a thickness of the solid layer or structure.
Reactant: One or more polymers subjected to heating for depolymerization. In some embodiments, the reactant comprises plastic, rubber, supramolecule (e.g., hydrogen-bonded acetic acid dimer), biomass, or any combination of the foregoing.
Peak temperature: A maximum temperature at a surface of one or more heating elements when energized (e.g., by application of a current pulse) and/or at a surface of a material being heated. In some embodiments, the peak temperature is greater than a melting temperature of a reactant being processed, for example, at least about 350° C. In some embodiments, a temperature at a material being processed (e.g., polymer and/or reactor) can match or substantially match (e.g., within 10%) the temperature of the heating element.

### Introduction

In order to convert polymers into smaller constituent molecules (e.g., monomers or other volatile species, for example, having a carbon number less than 20), the polymer can be subjected to one or more heating pulses of short duration (e.g., <1 s, for example, in a range of 10-500 ms) that break bonds between molecular fragments, while a rest period (e.g., non-heating or cooling period) between consecutive heating pulses can suppress pathways (e.g., random scission, dehydrogenation, and aromatization side reactions that have longer reaction timescales) toward undesired side products (e.g., aromatics, coke, soot, etc.). Thus, the polymer processing via pulsed heating can operate in the far-from-equilibrium regime, as opposed to the near-equilibrium reactions offered by constant heating. In some embodiments, the polymer processing via pulsed heating can offer high product yields (e.g., monomer conversion yields greater than 25%, e.g., in a range of 30-60%) without requiring a catalyst (e.g., substantially catalyst-free). In some embodiments, the pulsed heating can be provided via periodic activation of a heating element, for example, pulsed power waveforms applied to a Joule heating element.

In some embodiments, a reactor can be provided in contact with the polymer to be processed, for example, with the reactor in contact with a source of polymer (e.g., reservoir, container, delivery chamber, etc.) and/or with the polymer infiltrated within the reactor. The reactor can be one or more porous members (e.g., having a plurality of pores and/or microchannels therein) and can be disposed in thermal communication with the pulsed heating source. In some embodiments, the pulsed heating can heat the reactor to induce a spatial temperature profile therein (e.g., a temperature gradient). Since the pulsed heating is transient, the spatial temperature profile within the reactor can vary over time, thereby generating a spatio-temporal heating profile that control and/or enhance processing of the polymer. For example, pulsed heating applied to a first end of the reactor can conduct to an opposite second end of the reactor in contact with a polymer reactant, with a temperature at the first end being greater than a temperature at the second end.

In some embodiments, the spatio-temporal temperature gradient induced by pulsed heating can be such that the temperature at the first end is periodically greater than a decomposition temperature of the polymer (e.g., during and/or immediately after the heating period) but is otherwise less than the decomposition temperature at other times (e.g., during at least part of the non-heating period). Alternatively or additionally, in some embodiments, the spatio-temporal temperature gradient induced by pulsed heating can be such the temperature at the second end is maintained greater than a melting temperature of the polymer, for example, such that polymer can be melted via contact with the reactor. In some embodiments, the melted polymer can be continuously drawn into the reactor (e.g., the porous matrix and/or microchannel array) via capillary forces throughout the heating and non-heating periods. As the melted polymer progresses from the second end toward the first end, it is subjected to higher temperatures of the temperature gradient induced by pulsed heating. The melted polymer can be converted into the products (e.g., smaller constituent molecules, such as monomers) as it nears the first end, where the temperature periodically exceeds the decomposition temperature. In some embodiments, the resulting products are in a gas phase (e.g., volatile) when exposed to temperatures within the reactor (e.g., ≥350° C.), such that the products can evolve from the reactor for collection (e.g., by a collection or fume hood, and/or via a carrier gas, such as an inert gas) and subsequent use.

In some embodiments, in addition to or in place of the reactor, the spatio-temporal temperature gradient can be provided via one or more heating elements. For example, a spatial arrangement of multiple heating elements, operated in pulse heating mode with different peak temperatures, can be used to provide the spatio-temporal temperature gradient. Alternatively, in some embodiments, a single heating element can be used to provide the spatial temperature variation, for example, by provision of a spatially-varying insulation layer between the heating element and a heating zone for processing the polymer. Other mechanisms for providing a spatio-temporal temperature gradient are also possible according to one or more contemplated embodiments. Alternatively, in some embodiments, the polymer reaction can rely on pulse heating alone (e.g., without a temporal variation in temperature without the spatial variation) to convert the polymer into products.

As noted above, embodiments of the disclosed subject matter do not require any catalysts. Rather, the pulsed heating approach disclosed herein can offer high selectivity by controlling the reaction kinetics while also creating periodic high temperatures (e.g., 570° C. for 0.11 s) to enable rapid bond activation and thus a high reaction rate. Embodiments of the disclosed subject matter can be applied to process a wide range of synthetic polymers (e.g., plastic), rubber, natural macromolecules, supramolecules, and biomass, for example, to produce value-added feedstock chemicals and/or to recycle into monomers and/or other desirable products. For example, the polymer reactant can comprise a plastic or rubber having a carbon-carbon backbone (e.g., C—C bond connecting monomer fragments), such as but not limited to polypropylene (PP), polystyrene (PS), polyvinyl alcohol (PVA), polyvinyl acetate (PVAc), polyethylene (PE), poly(methyl methacrylate) (PMMA), acrylonitrile butadiene styrene (ABS), and/or polyvinyl chloride (PVC). Alternatively or additionally, the polymer reactant can comprise a plastic having a carbon-noncarbon backbone (e.g., C—X bond connecting monomer fragments, such as C—O or C—N), such as but not limited to polyethylene terephthalate (PET), polybutylene terephthalate (PBT), polyurethane (PU), nylon, unsaturated polyester (UPE), polycarbonate (PC), epoxy, and/or polyether. Alternatively or additionally, the polymer reactant can comprise a biomass derived from, produced by, and/or existing in a naturally-occurring plant (e.g., wood), insect, crustacean, algae, or other organism, such as but not limited to lignin, cellulose, rosin, chitin, and/or chitosan.

### Reactant Processing Methods

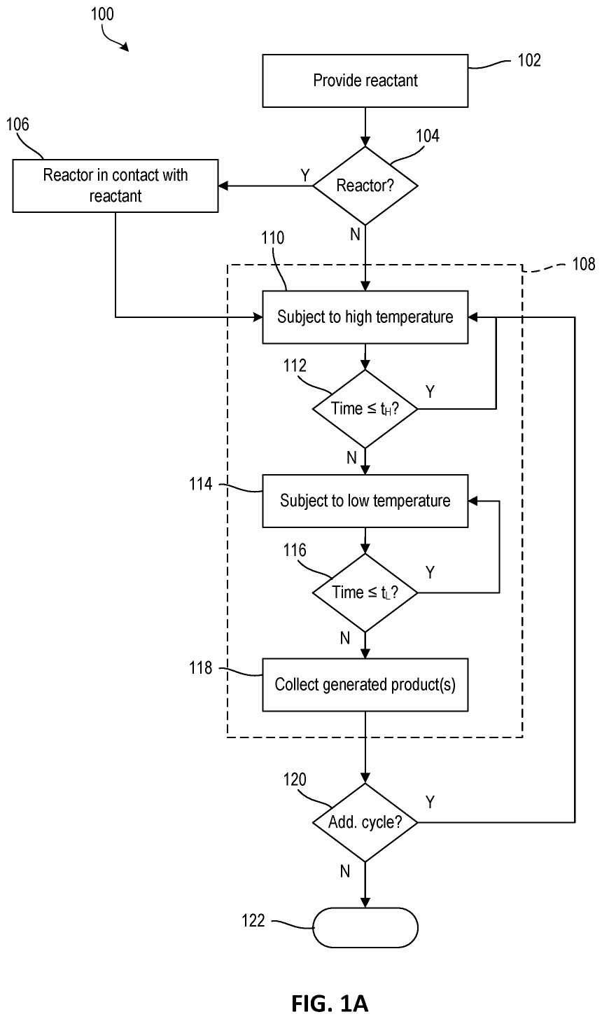

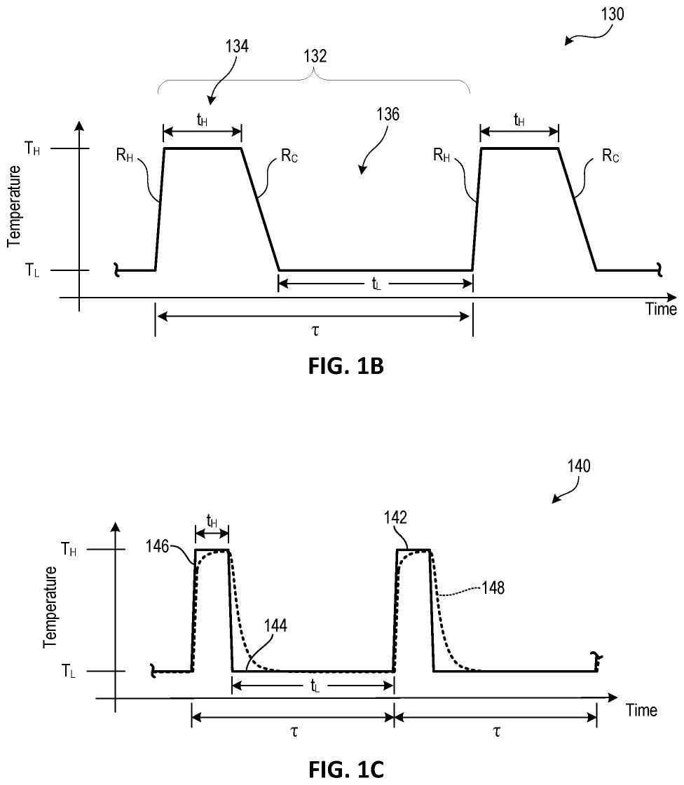

FIG. 1A illustrates a method 100 for processing of a reactant, for example, to convert one or more polymers to smaller constituent molecules (e.g., monomers) via periodic heating (e.g., pulsed heating). The method 100 can initiate at process block 102, where the reactant can be provided. In some embodiments, the one or more polymers of the reactant can be provided in pellet or bead form (e.g., having particle sizes less than 1 cm). In some embodiments, the provision of process block can include pre-processing the polymers, for example, in preparation for conversion via heating. In some embodiments, the pre-processing can include mechanical processing (e.g., shredding), for example, to reduce a size of the polymers (e.g., to form into pellets or beads, or to form into a powder (e.g., having particle size less than 1 mm). Alternatively or additionally, in some embodiments, the pre-processing can include collection processing, for example, sorting the polymers from other materials (e.g., different types of polymers or other materials in a recycling stream) and/or cleaning (e.g., removing food residue, dirt, grime, etc.) in preparation for processing.

The method 100 can proceed to decision block 104, where it is determined if a reactor is used, for example, to assist in generating a spatio-temporal temperature gradient. If a reactor is used, the method 100 can proceed from decision block 104 to process block 106, where the reactor is placed in contact with the reactant. For example, the reactant can be provided in a container or reservoir, and one end of the reactor can be placed in direct contact with the reactant. Alternatively or additionally, process block 106 can include infiltrating the reactant into the reactor, or impregnating the reactor with the reactant, via melting. In some embodiments, process block 106 can also include disposing the reactor with respect to one or more heating elements that provide pulsed heating to effect the polymer processing. For example, the reactor can be placed in soft contact with, or at least proximal (e.g., separated by a gap of 1 mm or less) to a heating element (e.g., a Joule heating element).

After process block 106, or if it was determined that no reactor was used at decision block 104, the method can proceed to process block 110, where the reactant (and/or the reactor, when used) is subjected to a peak temperature. For example, the peak temperature can be provided by energizing or otherwise activating a heating source (e.g., by applying a current pulse to a Joule heating element). When the reactor is used, the subjecting could be via a heating element closest to a first end of the reactor, and the heating of process block 110 can generate a temperature at the first end of the reactor that is greater than or equal to a decomposition temperature of the reactant. Alternatively or additionally, the heating of process block 110 can generate a temperature at a second end of the reactor in contact with the reactant (e.g., an end of the reactor that is opposite from the first end) that is greater than a melting temperature of the reactant. In some embodiments, the temperature at the second end of the reactor can be greater than the melting temperature of the reactant but less than the decomposition temperature of the reactant.

Alternatively, when the reactor is not used, the subjecting of process block 110 could be via a heating element disposed proximal to or in contact with the reactant. For example, in some embodiments, the reactant can be impregnated or infiltrated within the heating element. Alternatively, in some embodiments, the reactant can be maintained in the liquid phase, and the heating element disposed therein. In some embodiments, the heating of process block 110 can generate a temperature within the reactant (or at least part thereof) that is greater than a decomposition temperature of the reactant.

The method 100 can proceed to decision block 112, where it is determined if the end of a heating period has been reached. In some embodiments, the duration of the heating period, t_{H}, can be less than 1 s, for example, in a range of 10-500 ms. Alternatively or additionally, the duration of the heating period t_{H} can be optimized based on the type of reactant, use of reactor, processing cycle duration (e.g., t_{H}+t_{L}), etc., for example, to minimize or at least reduce production of undesired components (e.g., aromatics, coke, soot, etc.). For example, in some embodiments, the duration of the heating period can be less than or equal to 35% of the duration of the overall processing cycle (e.g., ≤10% of the processing cycle duration). If the end of the heating period has been reached, the method 100 can proceed from decision block 112 to process block 114; otherwise, the method 100 can return to process block 110 to continue the subjecting to peak temperature.

At process block 114, the reactant (and/or reactor when used) can be subjected to a low temperature during a non-heating or quench period. In some embodiments, the subjecting of process block 114 can be achieved by de-energizing (e.g., discontinuing power) or otherwise deactivating a heating element, whereby the low thermal mass of the heating element, reactant, and/or reactant can enable rapid cooling. Alternatively or additionally, in some embodiments, the subjecting of process block 114 can include passive or active cooling to quickly achieve a quench temperature. When the reactor is used, the subjecting of process block 114 can cause the temperature at the first end of the reactor (e.g., closest to the heating element) to drop below a decomposition temperature of the reactant.

In some embodiments, the subjecting of process block 114 can cause the temperature at the first end of the reactor to remain greater than the melting temperature of the reactant but less than the decomposition temperature. Alternatively or additionally, in some embodiments, the subjecting of process block 114 can be such that a change in the temperature at the first end of the reactor is greater than a change in the temperature at the second end of the reactor. Alternatively, when the reactor is not used, the subjecting of process block 114 can cause the temperature in the reactant and/or in the heating element to drop below a decomposition temperature of the reactant. In some embodiments, the subjecting of process block 114 can cause the temperature of the reactant to drop below a melting temperature of the reactant, for example, when the reactant was initially embedded within the heating element.

The method 100 can proceed to decision block 116, where it is determined if the end of the quench period has been reached. In some embodiments, the duration of the quench period, t_{L}, can be greater than the duration of the heating period, t_{H}. For example, the duration of the quench period can be at least two times of the duration of the heating period (e.g., t_{L}≥2×t_{H}). Alternatively or additionally, the duration of the quench period t_{L} can be optimized based on the type of reactant, use of reactor, processing cycle duration, etc., for example, to minimize or at least reduce production of undesired components (e.g., aromatics, coke, soot, etc.). If the end of the quench period has been reached, the method 100 can proceed from decision block 116 to process block 118; otherwise, the method 100 can return to process block 114 to continue the subjecting to low temperature.

At process block 118, the products generated by pulsed heating of process blocks 110-114 can be collected. In some embodiments, the products can be vaporized by the temperatures produced by process block 110 in a heating zone proximal to a heating element and/or within the reactor (when used). The gaseous products can thus be collected for further processing (e.g., separation and/or isolation), storage, and/or use. In some embodiments, the collection of process block 118 can include flowing to an outlet and/or storing in a container (e.g., gas collection bag). In some embodiments, the collection of process block 118 can be via a carrier gas flow (e.g., an inert gas, such as argon and/or nitrogen).

The provision of a single heating period (e.g., process block 110), a single quench period (e.g., process block 114), and collection (e.g. process block 118, which may be periodic or continuous with respect to performance of process blocks 110 and/or 114) may be considered a single processing cycle 108. After the quench period, the method 100 can thus proceed to decision block 120, where it is determined if a further processing cycle is desired. In some embodiments, processing cycles can be repeated until a batch of reactant has been exhausted. Alternatively or additionally, the processing cycle can be performed continuously or semi-continuously (e.g., in an industrial production system, with periodic downtime for maintenance, repair, etc.). In some embodiments, multiple processing cycles 108 performed on a reactant can produce a yield of constituent monomers greater than or equal to 25%, for example, in a range of 30-60%. Alternatively or additionally, in some embodiments, multiple processing cycles 108 performed on reactant can generate products have a selectivity for constituent monomers of at least 10%. If further processing cycles are desired, the method 100 can return to process block 110 to repeat the processing cycle 108; otherwise, the method 100 can end at terminal block 122.

Although illustrated separately, it is contemplated that various process blocks may occur simultaneously or iteratively. Indeed, in some embodiments, the collection of process block 118 may occur at the same time as, or at least overlapping with, the heating period of process block 110 and/or the quench period of process block 114. Furthermore, certain process blocks illustrated as occurring after others may indeed occur before. Although some of blocks 102-122 of method 100 have been described as being performed once, in some embodiments, multiple repetitions of a particular process block may be employed before proceeding to the next decision block or process block. In addition, although blocks 102-122 of method 100 have been separately illustrated and described, in some embodiments, process blocks may be combined and performed together (simultaneously or sequentially). Moreover, although FIG. 1A illustrates a particular order for blocks 102-122, embodiments of the disclosed subject matter are not limited thereto. Indeed, in certain embodiments, the blocks may occur in a different order than illustrated or simultaneously with other blocks. In some embodiments, method 100 may comprise only some of blocks 102-122 of FIG. 1A.

In some embodiments, a pulsed heating technique (also referred to as shock heating, programmable heating and quenching (PHQ), non-continuous heating, or temporal heating) can comprise one or more processing cycles, for example, processing cycle 108 formed by a heating period (e.g., high temperature application of process block 110) and a consecutive quench period (e.g., low temperature application of process block 114), as discussed above. Unlike continuous heating under near-equilibrium conditions, the pulsed heating technique disclosed herein employs periodic or non-continuous heating on a second or sub-second scale to conduct non-equilibrium or far-from-equilibrium thermochemical reactions. Compared with conventional steady-state approaches that employ continuous heating at constant temperatures, the disclosed pulsed heating technique allow for rapid switching between a low temperature (e.g., below 450° C.) and a high temperature (e.g., 550° C. or above) in the second or sub-second regime, for example, by simply varying the electric current applied to a Joule heating element. Alternatively or additionally, in some embodiments, the rapid switching can be between a temperature less than 300° C. and a temperature greater than 300° C. In some embodiments, the rapid quenching after a heating pulse can provide high selectivity and desired product yield, as well as lowering the average reaction temperature to improve energy efficiency and reduce energy costs.

Referring to FIG. 1B, an exemplary heating profile or waveform 130 for a processing cycle is shown. During each processing cycle 132, the reactant is subjected to a peak temperature, T_{H}, (e.g., greater than a decomposition temperature of the reactant) for a first period 134 (e.g., heating period) of the processing cycle and a lower quenching temperature, T_{L}. (e.g., at least 100° C. less than the peak temperature, T_{H}) for a second period 136 (e.g., cooling period) of the processing cycle (e.g., having a duration, τ, less than or equal to 10 s, for example, less than or equal to 5 s). In some embodiments, the temperature can be rapidly switched between the peak temperature T_{H} and the quenching temperature T_{L}, for example, via a heating rate RH of at least 100° C. (e.g., ≥103 K/s, such as 104-105 K/s, inclusive) and/or a cooling rate RC of at least 100° C. (e.g., ≥103 K/s, such as 104-106 K/s, inclusive). In some embodiments, the duration, t_{H}, of the first period 134 is less than the remainder of the processing cycle 132, for example, no more than 35% of the cycle period, t (e.g., t_{H} in a range of 10 ms to 500 ms, for a total cycle duration, τ, of 25 ms to 1.5 s). In some embodiments, the duration t_{H} of the first period 134 may be less than or equal to 10% of the cycle period, τ. Conversely, the duration, t_{L}, of the second period 136 for quench temperature can constitute the majority of the heating cycle period, τ, for example, at least 65% of the cycle period, τ (e.g., t_{L}≥90% of τ)

Although shown in idealized form in FIG. 1B, temperatures experienced in practical implementations of the pulsed heating technique may deviate slightly from the idealized form. For example, FIG. 1C illustrates an example of a pulsed heating profile 140 for operating a Joule heating element. While the waveform 146 of the applied electrical power follows the desired rectangular pulse configuration, with a first part 142 defining peak temperature and a second part 144 defining quench temperature, the actual temperature 148 generated by the heating element may deviate slightly therefrom, for example, due to hysteresis. Nevertheless, the embodiments of the disclosed subject matter can be constructed such that the temperature of the reactant can be rapidly changed between a peak temperature and a minimum temperature in each processing cycle in the second or sub-second regime.

Although the discussion above and elsewhere herein focuses on heating via rectangular or pseudo-rectangular pulses, embodiments of the disclosed subject matter are not limited thereto. Rather, other waveforms are also possible according to one or more contemplated embodiments. For example, a stepped heating profile could be used, where the temperature increases to the peak temperature and/or decreases from the peak temperature in incremental steps. In addition, while FIGS. 1B-1C illustrate the waveform for each processing cycle as being identical, embodiments of the disclosed subject matter are not limited thereto. Rather, more complex waveform patterns that are non-repeating are also possible. Even with arbitrary waveforms, the time between successive peak application parts can be selected to be less than ten seconds, such that each the time of each peak application is in the second or sub-second regime.

### Reactant Processing Setups and Systems

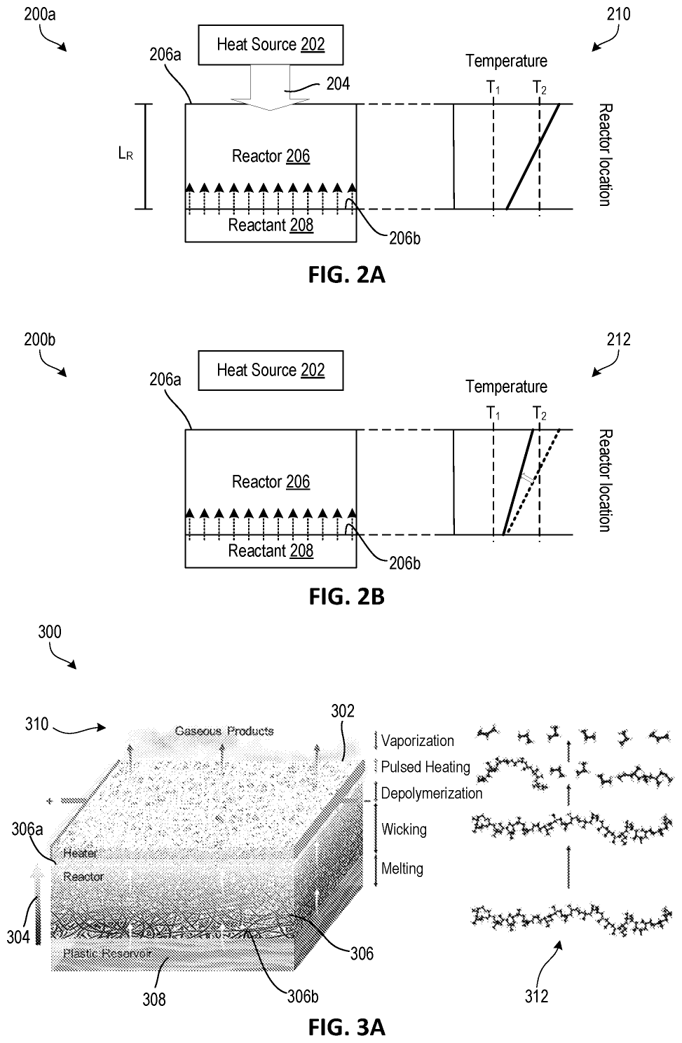

FIG. 2A illustrates a processing setup 200a during a heating period of a processing cycle. The processing setup 200a can include a porous reactor 206 disposed in contact with a reactant 208 at one end and a transient heating source 202 disposed proximal to the reactor 206. In some embodiments, the reactant 208 can be a single polymer. Alternatively or additionally, the reactant 208 can comprise multiple different polymers with similar melting temperatures and/or similar decomposition temperatures, for example, to enable simultaneous processing (e.g., depolymerization). Alternatively or additionally, in some embodiments, the reactant 208 can comprise multiple different polymers with different melting temperatures and/or different decomposition temperatures, for example, to enable separate or sequential processing (e.g., without having to separately sort plastics for recycling).

In some embodiments, the reactor 206 can have a plurality of pores, a plurality of microchannels, or both. For example, the reactor 206 can have a porosity of at least 40% (e.g., in a range of 50-95%). In some embodiments, the reactor 206 can be formed of carbon, ceramic, and/or metal (e.g., nickel foam, metal foam, etc.). For example, the reactor 206 can be formed of carbon felt or a carbon nanofiber film. In some embodiments, the reactor 206 can be a monolithic solid formed of a single layer with substantially consistent properties (e.g., porosity) across its thickness, L_{R} (e.g., LR≤1 cm, such as 2-8 mm). Alternatively, in some embodiments, the reactor 206 can be a monolithic solid formed of multiple layers, for example, each with the same or different properties. Alternatively or additionally, in some embodiments, the reactor 206 can be formed of multiple material layers coupled together in a single continuous structure. In some embodiments, the reactor 206 can have material properties (e.g., composition, porosity, etc.) that varies across its thickness, L_{R}, for example, in a continuous (e.g., gradual) or discontinuous (e.g., stepwise) manner. For example, the variation in material properties within the reactor 206 can be used to control movement of the melted reactant within the reactor and/or other aspects of the reactant processing.

In some embodiments, the heating source 202 can direct heat 204 at an end 206a of the reactor 206 directly opposite from the end 206b of the reactor 206 in contact with the reactant 208. In some embodiments, the transient heating source 202 can be a Joule heating system, a microwave heating system, a laser heating system, an electron beam heating system, a spark discharge heating system, a solar heating system (e.g., concentrated solar), a plasma heating system, or any other heating mechanism capable of providing a rapid heating rate, a rapid cooling rate, and/or the peak temperature via conduction, convection, and/or radiation. In some embodiments, the reactor 206 can be used to convert the pulsed heating provided by heating source 202 into a spatial temperature gradient that varies over time to control and/or enhance processing of the reactant 208 into one or more desired products. This reactor-based pulsed heating technique is referred to herein as spatio-temporal heating (STH). For example, during the heating period of setup 200a in FIG. 2A, the heating 204 generates a temperature profile 210 within the reactor 206 that varies across the thickness, L_{R}, from a high temperature at the first end 206a proximal to the heating source 202 to a low temperature at the second end 206b in contact with the reactant 208. For example, the temperature profile 210 can have a temperature in a region proximal to the second end 206b that exceeds a melting temperature T₁ of the reactant 208, such that the reactant 208 melts and is conveyed into the reactor 206 via capillary action. Meanwhile, the temperature profile 210 can also have a temperature in a region proximal to the first end 206a that exceeds a decomposition temperature T₂ of the reactant 208. Melted reactant that approaches the first end 206a of the reactor 206 can thereby be converted into one or more products (e.g., monomer).

During the quench period of setup 200b in FIG. 2B, the heating by heating source 202 is removed, thereby resulting in the reduced temperature profile 212 within the reactor 206. In particular, heat is internally conducted within the reactor 206 from the high temperature region proximal to the first end 206a to the lower temperature region proximal to the second end 206b. In some embodiments, this equilibration of temperature can maintain the temperature in the region proximal to the second end 206b greater than the melting temperature T₁, such that melted reactant can continue to be conveyed into the reactor 206. Meanwhile, the reduced temperature of the region proximal to the first end 206a can drop below the decomposition temperature T₂ of the reactant, thereby limiting further conversion of the reactant that may otherwise result in undesired products (e.g., aromatics, coke, soot, etc.).

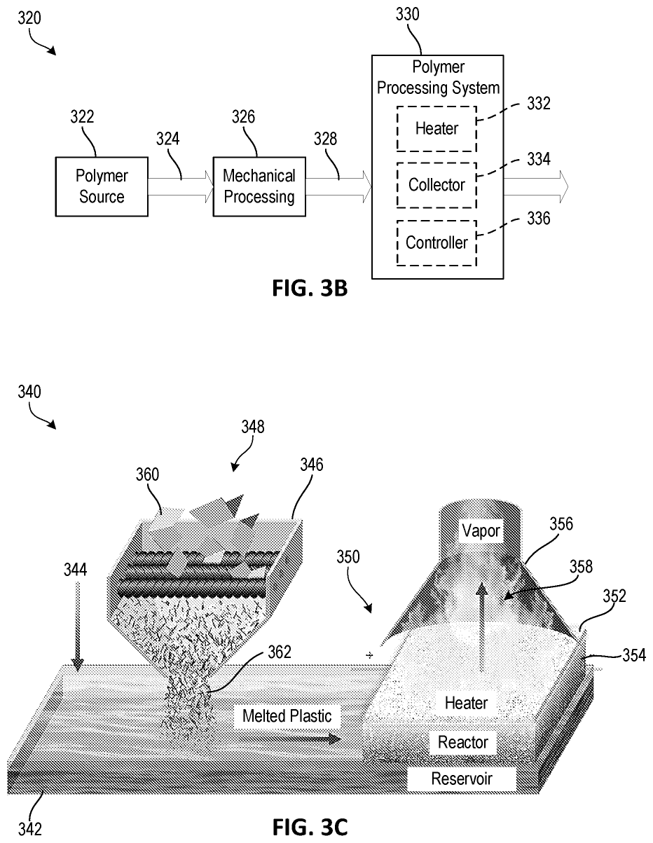

FIG. 3A illustrates a reactant setup 300 employing a Joule heating element 302 and a reactor layer 306, for example, to depolymerize a plastic contained in reservoir 308. A pulsed electrical current can be applied to the Joule heating element 302, which generates heat that conducts to the reactor layer 306 and the underlying plastic reactant in reservoir 308. The spatial temperature gradient 304 formed within the reactor as a result of the pulsed heating can cause the plastic to melt in the reservoir 308 and continuously wick upwards through the fiber network of the reactor layer 306 (e.g., from second end 306b toward first end 306a) via capillary forces. As a result of the induced temperature gradient 304, the plastic melt experiences regions of increasingly higher temperature as it climbs from the second end 306b toward the first end 306a of the reactor layer 306. After reaching a threshold temperature, the polymer chains begin to break and form monomers, oligomers, and other side products. Depolymerization can occur as the liquid polymer gets closer to the Joule heating element 302, as shown, for example, in the molecular transformation progression 312 in FIG. 3A. Upon formation, the lighter products (e.g., monomers or other volatile species) can be rapidly vaporized to form gaseous products 310 that evolve from the first end 306a of the reactor layer 306.

In some embodiments, the gaseous products 310 can be transported by an inert carrier gas, while the generated oligomers are retained in the liquid phase in the reactor layer 306, where they can be further depolymerized by the continued pulsed electrical heating of the Joule heating element 302. In some embodiments, the heating pulses can be applied with transient timescales (<1 s) that allow enough time to break the weakest C—C or C—O bonds that connect the monomer fragments while preventing the reaction from approaching chemical equilibrium. This controlled temporal heating profile helps limit the amount of side products (e.g., light hydrocarbons, aromatics, soot, coke, etc.) formed via random C—C bond scission, C—H bond breaking, and C—C bond coupling, which have higher energy requirements and therefore longer reaction timescales, for example to enable higher monomer selectivity.

In some embodiments, a processing system can include a pulsed-heating system and optionally one or more pre- or post-processing systems. For example, FIG. 3B provides a simplified illustration of an exemplary processing system 320. In the illustrated example, the processing system includes a polymer source 322, a mechanical processing station 326, and a pulsed heating station 330 (e.g., a depolymerization setup). In some embodiments, the polymer source 322 can provide a supply of plastic, for example, for recycling (e.g., an output of a sorting machine). The plastic can be conveyed from polymer source 322 by a first transport mechanism 324 (e.g., a conveyor system, gravity conveyance, etc.) to optional mechanical processing station 326. In some embodiments, the mechanical processing station 326 can prepare the plastic for processing via pulsed heating, for example, by shredding and/or grinding into smaller pieces. The plastic pieces can be conveyed from mechanical processing station 326 by a second transport mechanism 328 (e.g., a conveyor system, gravity conveyance, etc.) to pulsed heating station 330.

The pulsed heating station 330 can include a heating device 332, a collection device 334, and/or controller 336. In some embodiments, the heating device 332 can comprise a Joule heating system, a microwave heating system, a laser heating system, an electron beam heating system, a spark discharge heating system, a plasma heating system, and/or a solar heating system. In some embodiments, the collection device 334 can comprise a fume or collection hood. Alternatively or additionally, the collection device 334 can include a flow system (e.g., for conveying and/or capturing a carrier gas) and/or a separation system (e.g., for isolating vaporized products from a carrier gas). In some embodiments, the controller 336 can be configured to control (either directly or indirectly) one, some, or all of the components of the pulsed heating station 330. Alternatively or additionally, in some embodiments, controller 336 can be configured to control other components of the processing system 320, for example, transport mechanisms 324 and/or 328. In some embodiments, the pulsed heating station 330 can also include a reactor, for example, similar to the pulsed heating configurations described above and elsewhere herein.

In some embodiments, the polymer processing system can be configured for continuous processing. For example, FIG. 3C illustrates a large-scale, continuous processing system 340 that can be used for plastic recycling. In the illustrated example of FIG. 3C, plastic waste 360 can be provided to a mechanical processing stage 348, where the waste 360 is forced through a mechanical shredder 346 to be broken down into smaller solid plastic pieces 362 (e.g., to make it easier to melt). These smaller pieces 362 can be provided to an input end 344 of a reservoir 342 maintained at a temperature about the melting temperature of the plastic (e.g., via heating powered by renewable electricity or via natural heating such as concentrated sunlight). The melted plastic can flow in the reservoir 342 toward the depolymerization stage 350, where pulse heating by heating element 352 can subject the melted plastic to spatio-temporal heating within reactor 354, thereby producing product vapors 358 (e.g., monomers) with high selectivity. The gaseous products 358 can then be collected via collection hood 356 or suction nozzle for further separation and/or storage.

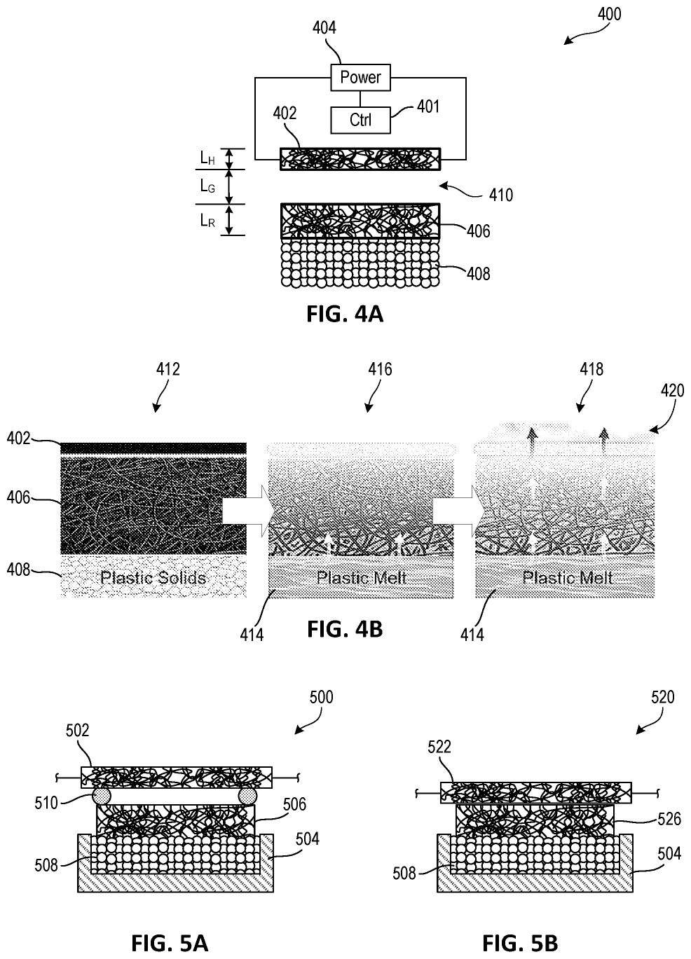

In some embodiments, the pulsed heating can be provided by Joule heating. For example, FIGS. 4A-4B show a polymer processing setup 400 that employs a Joule heating element 402 and a porous reactor 406 in contact with a solid reactant 408 (e.g. plastic particles) to be processed. A controller 401 can be operatively coupled to power source 404, for controlling application of power to Joule heating element 402 to effect the pulsed heating for polymer processing. In some embodiments, the Joule heating element 402 can be a carbon-based Joule heating element, for example, any of the heating system configurations disclosed in U.S. Publication No. 2018/0369771, published Dec. 27, 2018 and entitled “Nanoparticles and systems and methods for synthesizing nanoparticles through thermal shock,” U.S. Publication No. 2019/0161840, published May 30, 2019 and entitled “Thermal shock synthesis of multielement nanoparticles,” International Publication No. WO 2020/236767, published Nov. 26, 2020 and entitled “High temperature sintering systems and methods,” International Publication No. WO 2020/252435, published Dec. 17, 2020 and entitled “Systems and methods for high temperature synthesis of single atom dispersions and multi-atom dispersions,” and International Publication No. WO 2021/183949, published Sep. 16, 2021 and entitled “High-temperature shock heating for thermochemical reactions,” each of which is incorporate herein by reference.

In some embodiments, the Joule heating element 402 can be spaced from the reactor 406 by a narrow gap 410 (e.g., L_{G}≤1 mm). In some embodiments, the heating element 402 is also porous (e.g., having a porosity similar to that of the reactor 406), such that the gaseous products can pass through the heating element 402 for collection. For example, the Joule heating element 402 and the reactor 406 can both pieces of carbon felt disposed in soft contact with each other, and the reactor 406 can have a thickness, L_{R}, greater than a thickness, L_{H}, of the Joule heating element 402 (e.g., at least 2×the thickness of the Joule heating element). For example, in some embodiments, the reactor 406 can have a thickness, L_{R}, in a range of 2-8 mm, while the heating element 402 can have a thickness, L_{H}, in a range of 1-3 mm.

The reactor 406 is initially in contact with the solid reactant 408, as shown in the initial stage 412 of FIG. 4B. After pulsed heating via heating element 402 begins (e.g., after one or more initial processing cycles), the temperature at the bottom of the reactor 406 increases to above the melting temperature of the plastic, thereby melting the plastic in reservoir 414, as shown in immature stage 416. The melted plastic is then wicked up into the porous network of the reactor 406. Further pulsed heating via heating element 402 (e.g., after multiple processing cycles), the melted plastic can continue to climb toward the top of the reactor 406, where the plastic becomes depolymerized and resulting products (e.g., monomers) vaporized by the pulsed-heating-induced high temperature, as shown in mature processing stage 418 (e.g., where the spatio-temporal gradient has been fully developed). The gas-phase products 420 can evolve from the top porous later (e.g., heating element 402), in particular, without reacting further due to the limited heating time.

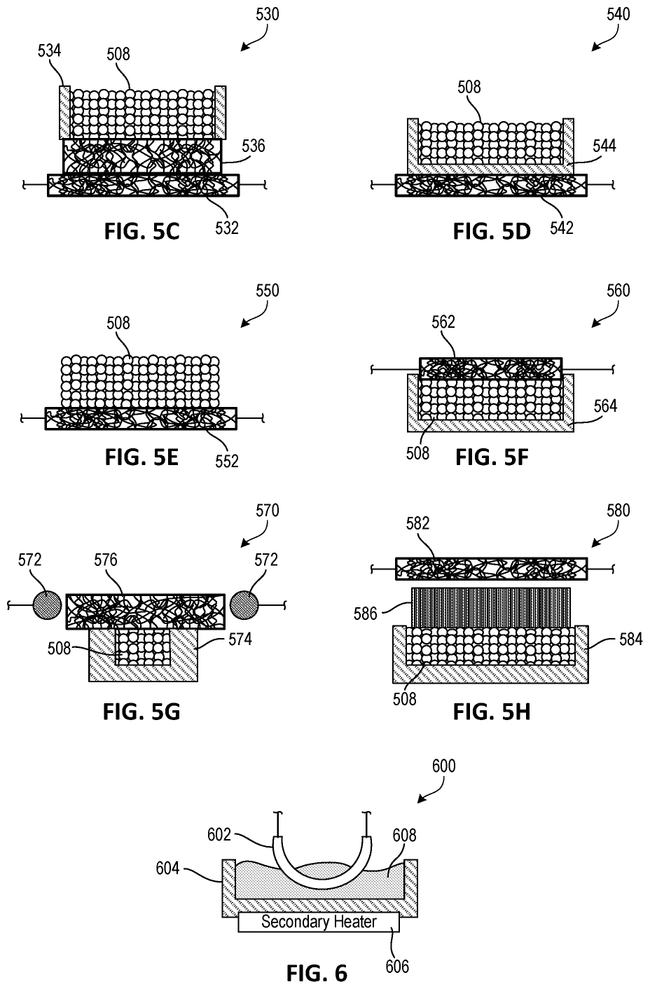

In the illustrated example of FIGS. 4A-4B, the heating element is spaced from the reactor by a narrow gap 410. Alternatively in some embodiments, the heating element may be in indirect contact with the reactor, for example, by one or more intervening layers. For example, FIG. 5A illustrates an exemplary setup for a polymer processing system 500, where a heating element 502 (e.g., Joule heating element) contacts reactor 506 via intervening member 510. The reactor 506 can be in contact with solid polymer particles 508 in container 504 at one end and with the intervening member 510 at an opposite second end. For example, the intervening member 510 (or multiple members) can be disposed at one or more outer edges of the reactor 506, such that a central portion of the reactor remains exposed to the heating element 502 but separated therefrom by a gap. In some embodiments, the intervening member 510 can be a thermally-insulating member and/or electrically-insulating member. Alternatively, in some embodiments, the heating element may be in direct contact with the reactor. For example, FIG. 5B illustrates an exemplary setup for a polymer processing system 520, where a top surface of reactor 526 is in soft contact with a heating element 522 (e.g., Joule heating element) is in soft contact (e.g., without pressing) while an opposite bottom surface of reactor 526 is in contact with solid polymer particles 508 in container 504 for processing. In some embodiments, the soft contact between the reactor 526 and the heating element 522 can be such that no or minimal electric current from the heating element flows through the reactor.

In the illustrated examples of FIGS. 4A-5B, the heating element is disposed above the reactor, and the reactor is disposed above the reactant container. However, embodiments of the disclosed subject matter are not limited thereto. Rather, in some embodiments, the arrangement of components can be reversed, with the heating element on the bottom. For example, FIG. 5C illustrates an exemplary setup for a polymer processing system 530, where the heating element 532 (e.g., Joule heating element) is disposed as a bottom layer with the reactor 536 in soft contact (e.g., without pressing) with a top surface of the heating element 532 or spaced from the reactor 536 by a narrow gap (e.g., ≤1 mm). In some embodiments, a bounding member 534 can be provided, for example, to contain polymer particles 508 atop the reactor 536. Alternatively in some embodiments, the bounding member 534 can be omitted, for example, when the reactor is otherwise constructed to retain the solid polymer particles 508 (e.g., with an indented surface) or otherwise delivered to the top surface of the reactor without likelihood of spilling off the top surface.

In the illustrated examples of FIGS. 4A-5C, the reactor is disposed between the heating element and the reactant. Alternatively, in some embodiments, the heating element can heat the reactant without an intervening reactor. For example, FIG. 5D illustrates an exemplary setup for a polymer processing system 540, where a container 544 holding polymer particles 508 is disposed over a top surface and in direct contact with heating element 542 (e.g., Joule heating element). Alternatively, in some embodiments, the heating element can be in direct contact with the reactant. For example, FIG. 5E illustrates an exemplary setup for a polymer processing system 550, where the polymer particles 508 are loaded directly on a top surface of the heating element 552 (e.g., Joule heating element). In another example, FIG. 5F illustrates an exemplary setup for a polymer processing system 560, where the polymer particles 508 are again loaded in a reactant container 564 but the heating element 562 (e.g., Joule heating element) is disposed in direct contact with or narrowly spaced from the polymer particles 508 in container 564.

In the illustrated examples of FIGS. 4A-5C, the heating element is disposed at an end of the reactor directly opposite from the reactant (e.g., with the heating element facing or in contact with one of the top and bottom surfaces of the reactor, and the reactant in contact with the other of the top and bottom surfaces of the reactor). However, in some embodiments, the heating element can be disposed at other locations with respect to the reactor. For example, FIG. 5G illustrates an exemplary setup for a polymer processing system 570, where the heating element 572 (e.g., Joule heating element) is disposed at opposite lateral edges (e.g., side ends) of the reactor 576. As with previous examples, the reactor 576 can be in contact with polymer particles 508 in container 574 (or the polymer particles can be disposed atop the reactor, for example, similar to the setup of FIG. 5C). However, instead of or in addition to the thermal gradient with respect to the thickness of the reactor 576, a spatio-temporal gradient can be created from the middle of the reactor 576 toward the outer edges of the reactor 576. Thus, in some embodiments, the polymer particles can be melted at the contacting surface of the reactor 576, and the liquid polymer can be wicked into the interior of the reactor 576, where it undergoes conversion as it reaches the periodic higher temperature regions toward the side edges of the reactor. Vaporized products may continue to evolve and/or be collected from the top end of the reactor 576. In the illustrated example of FIG. 5G, the heating element 572 is spaced from the reactor 576 by a gap (e.g., ≤1 mm). Alternatively, in some embodiments, the heating element 572 can be in soft contact with the lateral edges of the reactor 576. In some embodiments, the heating element 572 can surround some or all of a perimeter of reactor 576.

In the illustrated examples of FIGS. 4A-5C and 5G, the reactor is formed as porous material (e.g., carbon felt, carbon nanofiber membrane, etc.). Alternatively or additionally, in some embodiments, the reactor can have an array of engineered microchannels that also act to wick the liquid polymer toward the heating element via capillary action. For example, FIG. 5H illustrates an exemplary setup for a polymer processing system 580, where the heating element 582 (e.g., Joule heating element) is spaced from or in soft contact with a reactor 586. The reactor 586 can have microchannels therein that extend through an entire thickness thereof, for example, from polymer particles 508 in container 584 to an opposite end of the reactor 586 facing or in contact with the heating element 582. In some embodiments, the reactor with microchannels can be formed by a template method, for example, by mixing polymers onto vertically-aligned arrays of SiO₂ wires, performing pyrolysis to convert the polymers to carbon, and then dissolving the SiO₂ wires (e.g., using NaOH). Other techniques for forming a reactor with microchannels are also possible according to one or more contemplated embodiments.

In the illustrated examples of FIGS. 5E-5F, the heating element is in contact with the solid polymer particles prior to initiation of the processing via pulsed heating. However, in some embodiments, the polymer particles can be melted, and the heating element placed into contact with the liquid polymer prior to the processing via pulsed heating. For example, FIG. 6 illustrates an exemplary setup for a polymer processing system 600, where the heating element 602 (e.g., Joule heating element) is immersed in a volume of liquid-phase polymer 608 held by reactant container 604. In the illustrated example, a secondary heater 606 can be provided in thermal communication with the container 604 to melt the solid polymer prior to immersion of the heating element 602 therein. Alternatively or additionally, in some embodiments, the heating element 602 can initially be operated at a temperature that melts the solid polymer in container 604, after which the heating element 602 can be immersed in the resulting liquid polymer and pulsed heating initiated.

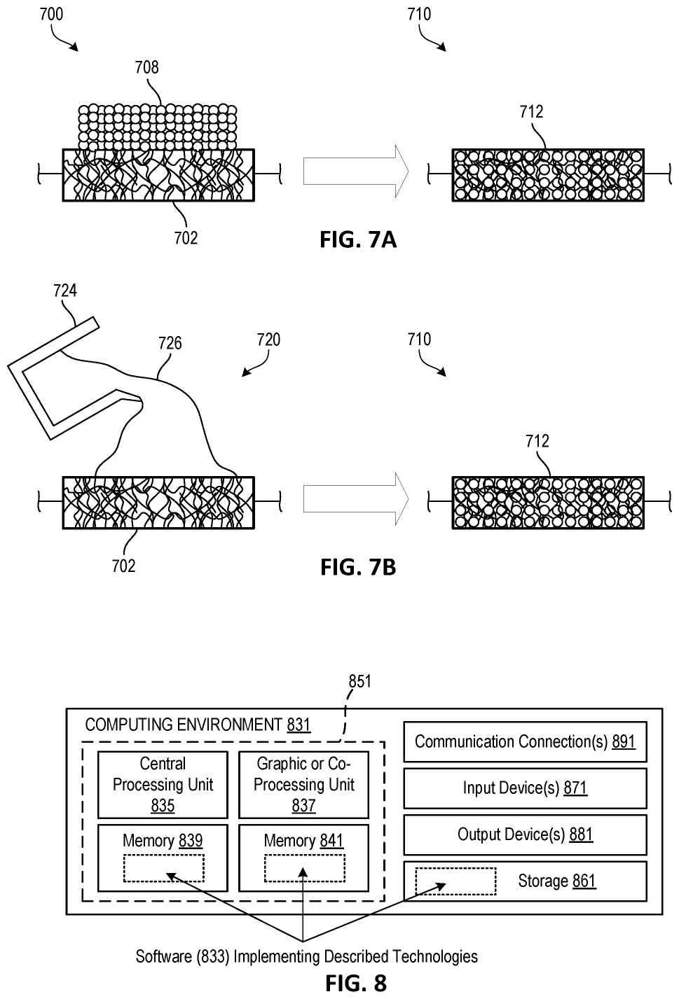

In the illustrated examples of FIGS. 5E, 5F, and 6, the reactant (whether solid polymer particles or liquid) is disposed separate from the heating element prior to initiation of the pulsed heating. Alternatively, in some embodiments, the reactant can be infused, infiltrated, injected, or embedded into the heating element prior to initiation of the pulsed heating. For example, FIG. 7A illustrates infiltration of polymer particles 708 into a porous heating element 702 (e.g., Joule heating element). At an initial stage 700, solid polymer particles 708 can be disposed atop the heating element 702 and subjected to heating (e.g., in a furnace, via a separate heating element, or via heating element 702) to cause melting of the polymer particles 708 without decomposition thereof. Alternatively, liquid polymer 726 can be poured from a container 724 onto a surface of a porous heating element 722, as shown at the initial stage 720 of FIG. 7B. For example, the polymer can be separately melted in container 724 prior to pouring onto or injecting into the heating element 702. In either of FIG. 7A or 7B, the liquid-phase polymer can infiltrate the heating element 702 via capillary action. The resulting polymer-infiltrated heating element 712, as shown at stage 710, can then perform pulsed heating to convert the polymer therein into one or more desired products (e.g., monomer).

### Computer Implementation

FIG. 8 depicts a generalized example of a suitable computing environment 831 in which the described innovations may be implemented, such as but not limited to aspects of method 100, controller 336, a controller of processing system 340, controller 401, and/or a controller of a reactant processing system. The computing environment 831 is not intended to suggest any limitation as to scope of use or functionality, as the innovations may be implemented in diverse general-purpose or special-purpose computing systems. For example, the computing environment 831 can be any of a variety of computing devices (e.g., desktop computer, laptop computer, server computer, tablet computer, etc.).

With reference to FIG. 8, the computing environment 831 includes one or more processing units 835, 837 and memory 839, 841. In FIG. 8, this basic configuration 851 is included within a dashed line. The processing units 835, 837 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 8 shows a central processing unit 835 as well as a graphics processing unit or co-processing unit 837. The tangible memory 839, 841 may be volatile memory (e.g., registers, cache, RAM), non-volatile memory (e.g., ROM, EEPROM, flash memory, etc.), or some combination of the two, accessible by the processing unit(s). The memory 839, 841 stores software 833 implementing one or more innovations described herein, in the form of computer-executable instructions suitable for execution by the processing unit(s).

A computing system may have additional features. For example, the computing environment 831 includes storage 861, one or more input devices 871, one or more output devices 881, and one or more communication connections 891. An interconnection mechanism (not shown) such as a bus, controller, or network interconnects the components of the computing environment 831. Typically, operating system software (not shown) provides an operating environment for other software executing in the computing environment 831, and coordinates activities of the components of the computing environment 831.

The tangible storage 861 may be removable or non-removable, and includes magnetic disks, magnetic tapes or cassettes, CD-ROMs, DVDs, or any other medium which can be used to store information in a non-transitory way, and which can be accessed within the computing environment 831. The storage 861 can store instructions for the software 833 implementing one or more innovations described herein.

The input device(s) 871 may be a touch input device such as a keyboard, mouse, pen, or trackball, a voice input device, a scanning device, or another device that provides input to the computing environment 831. The output device(s) 871 may be a display, printer, speaker, CD-writer, or another device that provides output from computing environment 831.

The communication connection(s) 891 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### Fabricated Examples and Experimental Results

A processing system was assembled according to the configuration of FIG. 3A, in particular, using a piece of carbon felt as a Joule heating element and a separate piece of carbon felt as a reactor. The dimensions of the carbon felt heater and reactor were 20 mm×10 mm×2 mm and 15 mm×10 mm×5 mm, respectively, in a typical experiment. Both ends of the carbon felt heater were wrapped with copper foil, which were then connected to a power supply through the alumina-protected copper wires and alligator clips. The gaps between the copper wire and alumina tube were filled with a thermoset epoxy. The reactor was laminated under the heater in soft contact (i.e., without pressing) and placed on top of a container made of inert titanium foil. The electrically connected top carbon heater layer is thinner (˜2 mm) to reduce the thermal inertia and enable rapid heating and cooling rates, while the bottom carbon reactor layer is relatively thick (˜5 mm) to allow liquid polymer wicking near the bottom of that layer and reaction at an appropriate temperature near the top.

The container was used to hold the plastic material prior to processing and the melted plastic during the processing via pulsed heating. The size of the titanium container matched that of the reactor. During processing, the temperature of the container can be much lower than the reaction temperature, such that negligible chemical reaction will occur within the reservoir. Instead, the conversion of the polymer may be primarily confined to within the reactor. The assembly including the heater, reactor, reservoir (e.g., reactant container) was placed in a flow reaction system made of a ½″ quartz tube and two vacuum T-fittings. The two ports of the T-fittings were used for wires and gas flow separately. In a typical experiment, ˜130 mg of polypropylene (PP) beads or ˜200 mg of polyethylene terephthalate (PET) pellets were used as the starting material. When PP bags or PET water bottles were used as the starting material, it was first cut into small pieces to fit in the reactant container.

Depolymerization using the disclosed techniques was first applied to PP as a model commodity plastic, as it holds one of the largest market shares among all synthetic polymers. The depolymerization of PP to propylene (i.e., its monomer, C₃H₆) has proven challenging due to the low steric hindrance effect of the methyl group, with numerous products of different carbon numbers typically observed after thermochemical decomposition under near-equilibrium conditions. In contrast, the spatio-temporal heating operates in the far-from-equilibrium regime, in which transient thermal excitation may enable higher monomer selectivity by suppressing the near-equilibrium pathways of C—H bond breakage, random C—C bond scission, and aromatization of secondary products (which requires higher energy and thus longer reaction timescales). Yet, the spatio-temporal heating also allows enough heating time for the weaker C—C bond between monomer fragments to break (which requires lower energy and shorter reaction timescales).

Applying a repeated electrical pulse to the top carbon layer (e.g., “heating on” square waves separated by “heating off” gaps) created a transient Joule heating effect that produced a temperature gradient between the top and bottom surfaces of the carbon reactor. The temperature gradient resulted in plastic melting at a base of the reactor, followed by continuous wicking up through the carbon reactor, where the material reaches sufficiently high temperatures that promote the pyrolysis reactions and product vaporization. As an example, it was found that turning the power on for 0.11 s (applying ˜25 V to the top heater layer) followed by 0.99 s of power off (on/off time ratio of 1:9) allowed ˜100-110 mg of PP material to be completely reacted after 35 min.

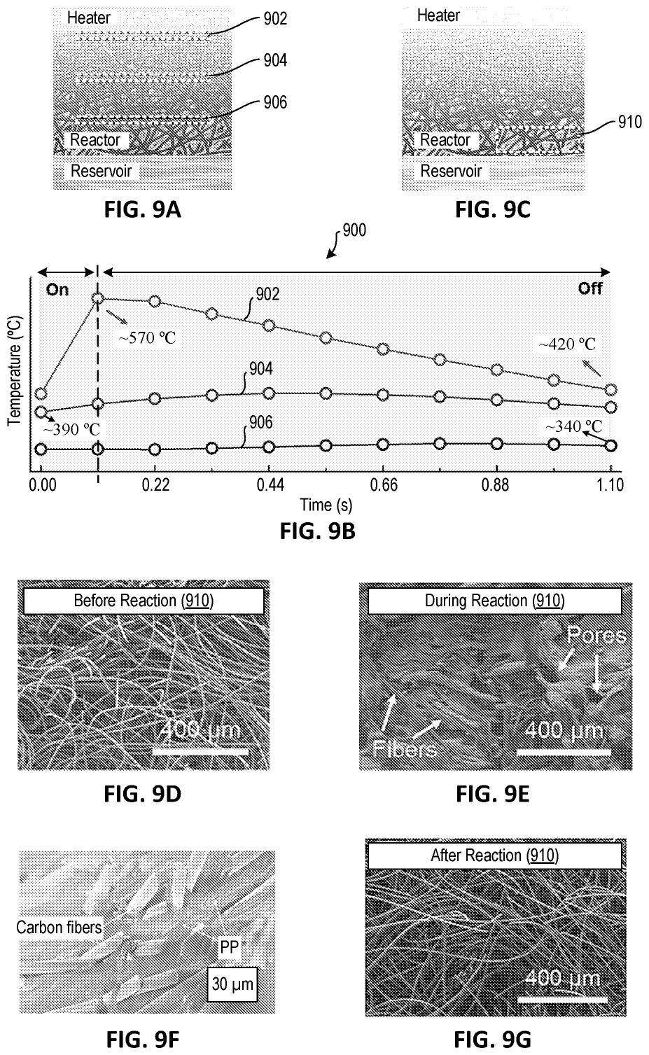

An infrared camera was used to measure the temperature distribution at the outer surface of the carbon felt layers. Based on the temperature distribution maps, three temperature profiles 900 within a period of 1.10 s (power on for 0.11 s, off for 0.99 s) were extracted, as shown in FIG. 9B. At the top section (e.g., section 902 in FIG. 9A) of the reactor layer, the temperature quickly rises to ˜570° C. after 0.11 s of applying the ˜25 V bias to the heater layer, then drops back to ˜420° C. within 0.99 s after removing the power input to complete the power on/off cycle (corresponding to a cooling rate of ˜150° C./s). The temperature range at the top section of the reactor layer is slightly higher than the temperatures used in the literature for PP pyrolysis as well as the PP decomposition temperature (˜440° C.) according to thermal gravimetric analysis, suggesting that the major reaction likely occurs near this region with fast rates. Meanwhile, the middle section (e.g., section 904 in FIG. 9A) and bottom section (e.g., section 906 in FIG. 9A) of the reactor layer exhibited much milder temperature variation (<35° C.) within one power on/off period (e.g., processing cycle) due to the large thermal inertia and gradual heat transfer from the top to the bottom of the reactor.

This indicates that the reactants near the top of the reactor are subjected to pulsed heating, while those near the bottom of the reactor undergo almost continuous heating at nearly constant temperatures. These three temperature profiles also demonstrate a temperature gradient from the top (>420-570° C.) to the middle (390-420° C.) and bottom (˜340° C.), in which most of the reaction products form near the top of the reactor layer due to the higher reaction rates at higher temperatures. The reactor layer can help ensure the continuous wicking and reaction processes by regulating the temperature gradient. In some cases, a single layer (e.g., without reactor) can be used to electrically heat the entire plastic melt in the container, but the processing system should be designed to avoid, at least reduce, the large thermal inertia and fluidity of the plastic melt from undermining accurate control of the temperature distribution and therefore the reaction kinetics.

The wicking of the plastic during processing via pulsed heating was monitored using scanning electron microscopy (SEM), focusing on the bottom region 910 of the reactor layer, as shown in FIG. 9C. As shown in FIG. 9D, the porous reactor layer can be composed of a network of carbon fibers. During operation, the network can gradually be filled by the plastic melt (e.g., after 10-15 min of pulsed heating (0.11 s power on, 0.99 s power off, ˜25 V)), as shown in FIGS. 9E-9F. After ˜35 min, the pyrolysis products in the reactor included oligomers. After ˜55 min, all the wicked polymer had reacted and the majority of the products had vaporized, with the reactor layer once again returning to its original state, as shown in FIG. 9G. Additionally, there was negligible difference in the weight of the reactor/reservoir prior to the loading of PP and after 55 min of the operation, indicating the completion of the reaction and the minimal formation of coke and soot species. As noted above, the fibers in the reactor (carbon felt) do not need to be loaded with catalysts to conduct the reaction, although in some cases, catalytic residues may remain from the plastic reactant. Thus, catalyst degradation is a non-issue for the disclosed processing system, which can ensure good durability and reusability of the system. This makes the electrified STH approach unsusceptible to catalyst degradation, thereby ensuring good durability and reusability of the system.

Gas chromatography with a flame ionization detector (GC-FID) was used to quantify the yield of various species (e.g., CH₄, C₂H₄, C₃H₆, etc.) in the argon carrier gas during the PP pyrolysis reaction. In particular, the gas sample was collected at the exit of the reaction system periodically using a gas sampling bag. 50 μL gas samples were then extracted from the gas bag via a gas tight syringe and injected into the injection ports of the GC-FID. A thermal conductivity detector was used to quantify an internal standard gas (argon) to ensure the consistency of each measurement. Standard gases of CH₄, C₂H₄, and C₃H₆ were injected to calibrate the peak areas from GC-FID. Liquid products were detected and qualitatively measured by gas chromatography-mass spectrometry (GC-MS) analysis. The depolymerization products in the liquid phase were in part collected with the carrier gas downstream in an acetone-filled vial. The rest of the products was condensed in the quartz tube, which was rinsed off using acetone and combined with the downstream products. The acetone solution was filtered through a 0.45 μm syringe filter before injecting into the GC-MS. The products were identified based on the NIST08 and NIST08s libraries, and the percentages of the peaks were calculated from the total ion chromatogram (TIC) peak area.

Unlike continuous heating, the pulsed heating can be controlled by varying the input power and/or the on-off timescales, thereby enabling tuning of heating duration, frequency, heating pulse temperature, and/or temperature gradient in the reactor to control (e.g., optimize) performance of the polymer processing (e.g., depolymerization). To explore this capability, reaction products were monitored for various heating durations of 0.02 s, 0.11 s, and 0.33 s within the same total period of 1.10 s (corresponding to power on/off time ratios of 1:54, 1:9, and 3:7) while maintaining a comparable peak temperature of 570±20° C. by varying the voltage applied. To account for both the selectivity and conversion of the reaction, the monomer yield (i.e., product yield=product selectivity×plastic conversion) was compared after 35 minutes. To determine product yield of PP pyrolysis, the GC-FID peak areas of CH₄, C₂H₄, and C₃H₆ (major gaseous products from PP pyrolysis in this study by either STH or continuous heating) were quantitatively calibrated by injecting known amounts of standard gases. Based on the measured peak areas, the mass of each gaseous product from a batch reaction can be derived. Since minimal products were found in the liquid or solid phase upon complete reaction (e.g., after 55 min of pulsed heating operation using 0.11 s power on, 0.99 s power off, and ˜25 V), the product yield is calculated by dividing the mass of the product of interest by the reacted PP (feed mass in the container minus the residue mass in the reactor and the container) after 35 min of reaction.

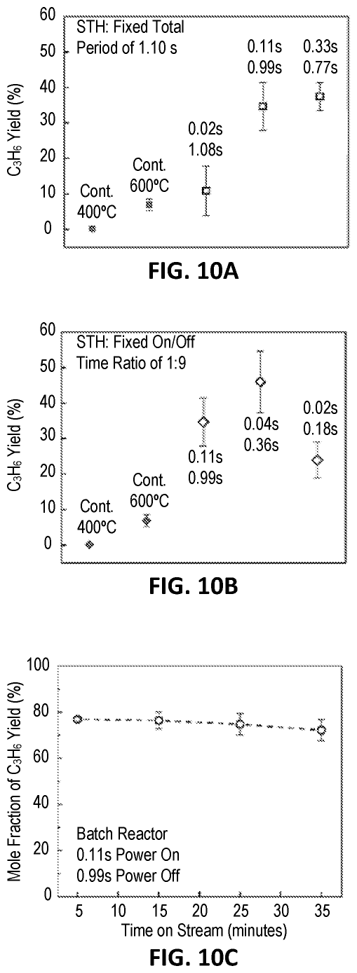

The stability measurement shown in FIG. 10C uses the mole fraction of C₃H₆ as the y-axis, which is the mass percentage of C₃H₆ among all three major gaseous products (i.e., CH₄, C₂H₄, and C₃H₆). The selectivity to other gas phase products are estimated to be <5%. According to the GC-FID results, the yield of the C₃H₆ monomer was found to increase from ˜11% to ˜35% to ˜37% as we increased the heating durations from 0.02 s to 0.11 s to 0.33 s, as shown in FIG. 10A. A shorter heating duration of 0.02 s results in a larger fraction of light hydrocarbons (i.e., the CH₄, C₂H₆, C₂H₄, and C₃H₆ peaks increase while the C_{≥4} peaks decrease) compared to using longer heating durations of 0.11 s and 0.33 s. However, the overall reaction rate using a heating duration of 0.02 s is low due to the limited energy input timescale of only 0.02 s in one period of 1.10 s, which results in lower conversion of the reactant (˜60-80% unreacted after 35 min), therefore lower yield. On the other hand, increasing the heating duration from 0.11 s to 0.33 s does not change the C₃H₆ yield dramatically (˜35% vs. ˜37%, as shown in FIG. 10A) due to a tradeoff between conversion and selectivity. That is, using a heating duration of 0.11 s results in a larger fraction of light hydrocarbons including the monomer (i.e., higher selectivity) but lower conversion (˜80%), while using a heating duration of 0.33 s leads to a smaller fraction of light hydrocarbons (i.e., lower selectivity) but higher conversion (˜100%) after 35 min.

To explore how the heating duration affects the product yield at comparable PP conversion (˜80%), the same power on/off time ratio of 1:9 was used for various heating durations (i.e., 0.11 s, 0.04 s, and 0.02 s) while maintaining a comparable peak temperature (i.e., 570±20° C.). As shown in FIG. 10B, the C₃H₆ yield first increases with the decrease of the heating duration (from 0.11 to 0.04 s) from ˜35% to ˜46%, then drops to ˜24% for 0.02 s of heating. The increased monomer yield by changing the heating duration from 0.11 to 0.04 s is likely due to the suppression of side reactions (dehydrogenation, random scission, and aromatization) at a shorter timescale as the reaction is kept further away from the chemical equilibrium. On the other hand, since the cooling rate in the reactor layer is ˜150° C./s, the decreased monomer yield shown in FIG. 10B by changing the heating duration from 0.04 to 0.02 s could be a result of the decreased cooling duration from 0.36 to 0.18 s (by keeping the same power on/off time ratio of 1:9), which does not shut down the side reactions effectively.

In addition to using pulsed electrical heating, control experiments of PP pyrolysis were conducted using continuous heating in the same setup at different temperatures, which showed low C₃H₆ yields (˜0% for 400° C. and ˜8% for 600° C.), as shown in FIGS. 10A-10B. The low yields can be explained by molecular dynamics (MD) simulations, in which the polymer chain breaking and monomer formation processes are quickly overtaken by dehydrogenation and aromatization side reactions toward the formation of soot-like species as the reaction approaches chemical equilibrium.

Using a pulsed heating program of 0.11 s power on, 0.99 s power off (˜25 V), the mole fraction of the C₃H₆ monomer in the gas phase (among CH₄, C₂H₄, and C₃H₆ as major products) was monitored over time to evaluate the stability of the system. As shown in FIG. 10C, throughout the entire batch reaction (35 min with 130 mg of PP), the mole fraction of C₃H₆ in the gas phase remained high and stable (e.g., >70%). In addition, due to the good stability, the optimized C₃H₆ yield by the pulsed heating approach (up to ˜46%) was also higher compared to previously reported values using conventional continuous heating under near-equilibrium conditions (˜10% by catalyst-free pyrolysis; <25% even with catalysts). These results indicate that our catalyst-free, far-from-equilibrium pulsed heating approach enables a unique depolymerization pathway and superior monomer yield compared to conventional approaches for thermochemical plastic decomposition. In some embodiments, the performance can be further enhanced toward better reactivity and product selectivity, for example, by use of more complex protocols with sculpted heating profiles (e.g., triangular wave, stepped profile, etc.).

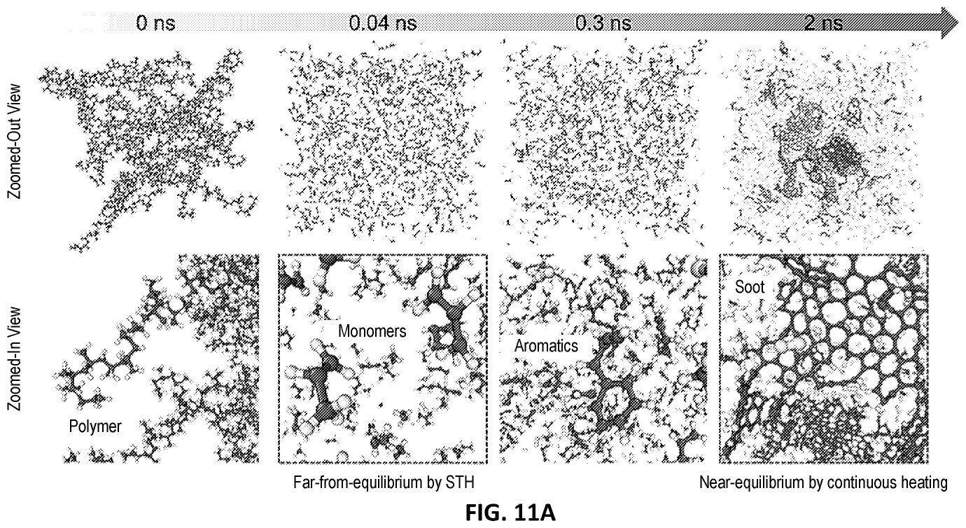

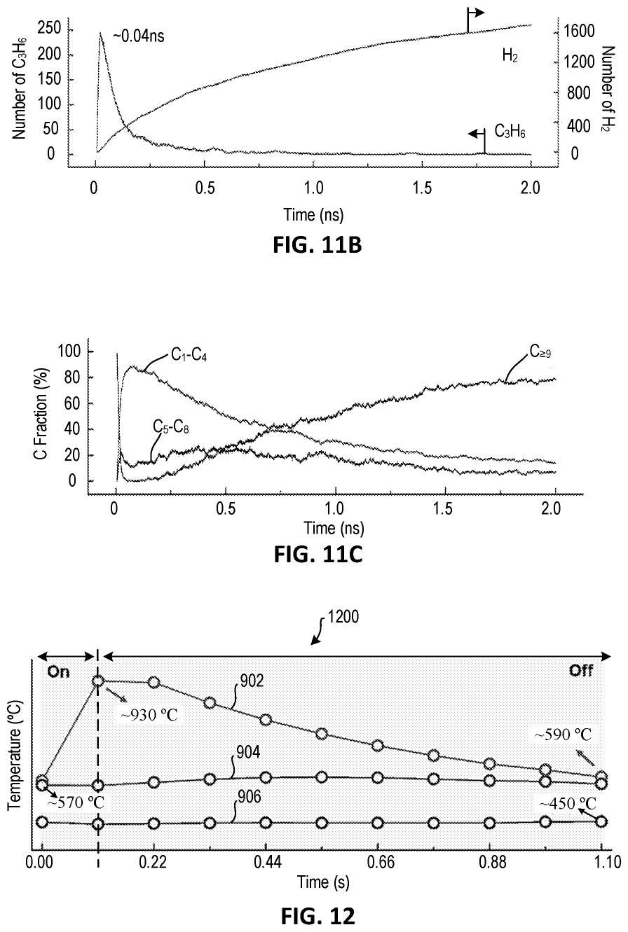

To investigate the reaction chemistry behind the PP pyrolysis under near- and far-from-equilibrium conditions, reactive MD simulations were performed by reactive force-field (ReaxFF) simulations. The simulation of the reaction process was conducted at 2727° C. to extract the complete reaction progress from the starting polymeric molecules to the near-equilibrium products under continuous heating. A series of representative images are shown in FIG. 10A to show the molecular-level evolution from polymer to various products (e.g., oligomer, monomer, aromatics, soot-like species) as a function of the simulated reaction time (from 0 to 2 ns). At the initial stage, PP first cracks into smaller polymeric species, oligomers, and monomer fragments (FIG. 10A, at 0.04 ns), which quickly dehydrogenate, recombine, and gradually form larger molecules (FIG. 10A, at 0.3 ns and 2 ns). The number of monomer species were plotted as a function of the simulated reaction time (up to 2 ns), as shown in FIG. 11B. It was found that the number of monomers quickly peaks at ˜0.04 ns, then decreases, as shown in FIG. 11B. The C—C bond connecting the monomer fragments features the lowest dissociation energy compared to the C—H and other C—C bonds, which renders the short timescale of the monomer formation process. Meanwhile, the number of H₂ molecules increases throughout the simulated reaction timeframe, indicating that dehydrogenation (C—H bond breaking, which has a longer timescale) occurs continuously as the reaction proceeds to chemical equilibrium.

A more detailed analysis on the carbon mass distribution among different carbon-containing species quantitatively reveals the reaction progress, as shown in FIG. 11C. At the beginning of the simulated reaction timeframe, all of the carbon mass occurs as C₉₊ species since the simulation box is filled with large polymeric molecules. These polymers then split into smaller fragments through C—C bond scissions upon heating, leading to the increase of C₁-C₄ (i.e., lighter hydrocarbons, including the monomer) and C₅-C₈ species (i.e., heavier aliphatic hydrocarbons and small aromatics). As the reaction proceeds to chemical equilibrium under continuous heating, these species undergo dehydrogenation, C—C coupling, and aromatization, forming soot-like species towards the end of the simulated reaction timeframe (corresponding to t=2 ns in FIG. 11A).

Note that in order to speed up the simulation, a much higher temperature was used than that actually employed in the pulsed heating experiments (i.e., 2727° C. vs. ˜570° C.), which leads to substantially shorter timescales than the experimentally explored heating durations (nanoseconds vs. milliseconds). Nevertheless, the aforementioned trends and reaction progress are representative for PP pyrolysis, as they are also observed at 1727 and 2227° C., with lower temperature leading to longer timescale to achieve the highest monomer count. Based on the simulated time required to achieve the highest number of monomers at different temperatures, the simulation results were extrapolated to estimate that it takes ˜0.01 s under the experimental conditions (Tₚₑₐₖ=˜570° C.) to reach the peak monomer number, which is reasonably close to the applied heating durations (e.g., 0.04 s, 0.11 s) by pulsed heating that were shown to increase the monomer yield compared to continuous heating. These results indicate that the catalyst-free, far-from-equilibrium pulsed heating approach can dramatically improve the monomer yield through transient thermal excitation, which can interrupt the pyrolysis process at the beginning where monomer yield is high. Meanwhile, the dehydrogenation and aromatization side reactions are slowed down by turning off the energy input and rapidly reducing the temperature before a large amount of aromatics and soot are formed.

In addition to depolymerizing PP, the pulsed heating approach was also applied to depolymerize PET as a representative polyester. Polyesters have been widely used as plastics but also as fabrics, whose recycling holds great importance for environmental and economic considerations. Although polyesters can be depolymerized via hydrolysis, this process is time-consuming and environmentally unfriendly. While thermochemical approaches can be more efficient and scalable, conventional methods typically suffer from low yield and poor selectivity. In contrast, the pulsed heating approach disclosed herein can avoid, or at least improve upon, the issues with conventional techniques. To depolymerize PET, the same processing system was used to apply a higher pulse peak temperature compared to PP, given PET's higher melting point (˜250° C. versus ˜150° C. for PP). By increasing the peak temperature of the heater, the temperature at the bottom of the reactor increases accordingly, which helps ensure good fluidity of the reactant for effective and continuous wicking through the reactor layer. As a non-optimized, proof-of-concept demonstration, a power on (heating) duration of 0.11 s, a power off (cooling) duration of 0.99 s, and a voltage of ˜50 V were used to generate a pulse peak temperature of ˜930° C., as shown in the temperature profiles of FIG. 12.

The product yield (i.e., relative abundance) of PET pyrolysis was qualitatively estimated based on the GC-MS peak area percentages of the liquid phase products (only considering the 1,4-benzendicarboxylic acid monomer fragments) after 55 min of reaction. Note that minimal solid products were detected (<3 wt % relative to the feed mass of PET) after the PET pyrolysis by pulsed heating, and ˜200 mg PET can be fully decomposed after 55 min (i.e., ˜100% conversion). The qualitative product analysis of the depolymerized PET by GC-MS showed a monomer yield (relative abundance of 1,4-benzenedicarboxylic acid) of up to ˜43% along with ˜6% monomer-related product (relative abundance of 1,4-benzenedicarboxylic acid, 1-ethenyl ester), which adds up to ˜49%. The monomer of 1,4-benzenedicarboxylic acid is likely formed based on a β-CH hydrogen transfer mechanism during PET pyrolysis in pure argon, which is supported by the presence of 1,4-benzenedicarboxylic acid, 1-ethenyl ester in the liquid phase products and acetylene in the gas phase products.

Note that in the aforementioned experiments, raw materials of PP and PET were used in order to understand the depolymerization chemistry during the pulsed heating process without introducing additional variables, such as additives and impurities. Nevertheless, comparably high monomer yields can be achieved from depolymerizing commercial plastic products as well. For example, a ˜33% C₃H₆ monomer yield was achieved in the depolymerization of a commercial PP plastic bag using a pulsed heating operation of 0.11 s power on, 0.99 s power off, and ˜25 V, which is close to the ˜35% yield from the PP beads under the same conditions. Similarly, using a program of 0.11 s power on, 0.99 s power off, and ˜50 V, a ˜45% total yield of 1,4-benzenedicarboxylic acid and 1,4-benzenedicarboxylic acid, 1-ethenyl ester was obtained from a commercial PET plastic bottle, which is close to the ˜49% total yield from the PET pellets under the same conditions.

### Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.
Clause 1. A method for processing a reactant, the method comprising:
   subjecting the reactant to multiple consecutive processing cycles, each processing cycle comprising a first period with heating applied and a second period immediately following the first period with no heating applied, a duration of each processing cycle being less than or equal to 10 seconds, a duration of each first period being less than 1 second,
   wherein the reactant comprises one or more polymers, and
   the subjecting is effective to convert at least some of the reactant into one or more first products.
Clause 2. The method of any clause or example herein, in particular, Clause 1, wherein the subjecting is performed without use of a catalyst.
Clause 3. The method of any clause or example herein, in particular, any one of Clauses 1-2, wherein the subjecting is performed as a far-from equilibrium process.
Clause 4. The method of any clause or example herein, in particular, any one of Clauses 1-3, wherein the one or more polymers comprise a plastic, rubber, supramolecule, biomass, or any combination of the foregoing.
Clause 5. The method of any clause or example herein, in particular, any one of Clauses 1-4, wherein the one or more polymers comprise a plastic or rubber having a carbon-carbon (C—C) backbone.
Clause 6. The method of any clause or example herein, in particular, Clause 5, wherein the plastic or rubber is polypropylene (PP), polystyrene (PS), polyvinyl alcohol (PVA), polyvinyl acetate (PVAc), polyethylene (PE), poly(methyl methacrylate) (PMMA), acrylonitrile butadiene styrene (ABS), polyvinyl chloride (PVC), or any combination of the foregoing.
Clause 7. The method of any clause or example herein, in particular, any one of Clauses 1-6, wherein the one or more polymers comprise a plastic having a carbon-non-carbon (C—X) backbone.
Clause 8. The method of any clause or example herein, in particular, Clause 7, wherein the plastic is polyethylene terephthalate (PET), polybutylene terephthalate (PBT), polyurethane (PU), nylon, unsaturated polyester (UPE), polycarbonate (PC), epoxy, polyether, or any combination of the foregoing.
Clause 9. The method of any clause or example herein, in particular, any one of Clauses 1-8, wherein the one or more polymers comprise a biomass selected from lignin, cellulose, rosin, chitin, chitosan, or any combination of the foregoing.
Clause 10. The method of any clause or example herein, in particular, any one of Clauses 1-9, wherein the heating during each first period is provided by Joule heating, microwave heating, laser heating, electron beam heating, spark discharge heating, plasma heating, solar heating, or any combination of the foregoing.
Clause 11. The method of any clause or example herein, in particular, any one of Clauses 1-10, wherein the subjecting is such that a yield of the one or more constituent monomers is at least 25 wt %.
Clause 12. The method of any clause or example herein, in particular, any one of Clauses 1-11, wherein the subjecting is such that a yield of the one or more constituent monomers is in a range of 30-60 wt %.
Clause 13. The method of any clause or example herein, in particular, any one of Clauses 1-12, wherein the duration of each processing cycle is less than or equal to 1.5 seconds.
Clause 14. The method of any clause or example herein, in particular, any one of Clauses 1-13, wherein, for one, some, or all of the processing cycles, a duration of the first period is less than a duration of the second period of the corresponding processing cycle.
Clause 15. The method of any clause or example herein, in particular, any one of Clauses 1-14, wherein, for one, some, or all of the processing cycles, a duration of the first period is less than or equal to 10% of a duration of the second period of the corresponding processing cycle.
Clause 16. The method of any clause or example herein, in particular, any one of Clauses 1-15, wherein, for one, some, or all of the processing cycles, a duration of the first period is in a range of 10-500 milliseconds, inclusive.
Clause 17. The method of any clause or example herein, in particular, any one of Clauses 1-16, wherein the subjecting is such that a selectivity for the one or more constituent monomers is at least 10%.
Clause 18. The method of any clause or example herein, in particular, any one of Clauses 1-17, wherein:
   at least a first end of a reactor is disposed in contact with the reactant prior to the subjecting,
   the reactor comprises a plurality of pores, a plurality of microchannels, or both,
   the subjecting is such that a temperature gradient is induced across a thickness of the reactor, and
   during the subjecting, melted reactant is transported into the reactor via capillary action.
Clause 19. The method of any clause or example herein, in particular, Clause 18, wherein the reactor comprises one or more layers formed of carbon, ceramic, metal, or combinations of the foregoing.
Clause 20. The method of any clause or example herein, in particular, any one of Clauses 18-19, wherein the thickness of the reactor is in a range of 2-8 millimeters, inclusive.
Clause 21. The method of any clause or example herein, in particular, any one of Clauses 18-20, wherein a porosity of at least a portion of the reactor at the first end is at least 40%.
Clause 22. The method of any clause or example herein, in particular, any one of Clauses 18-21, wherein a porosity of at least a portion of the reactor at the first end is in a range of 50-95%, inclusive.
Clause 23. The method of any clause or example herein, in particular, any one of Clauses 18-22, wherein a porosity of a portion of the reactor at the first end is different from that of a portion at a second end of the reactor opposite the first end.
Clause 24. The method of any clause or example herein, in particular, any one of Clauses 18-23, wherein the heating during each first period is provided by a Joule heating element, and the reactor is disposed in contact with or adjacent to the Joule heating element.
Clause 25. The method of any clause or example herein, in particular, Clause 24, wherein a porosity of at least a portion of the Joule heating element proximal to the reactor is at least 40%.
Clause 26. The method of any clause or example herein, in particular, any one of Clauses 24-25, wherein a porosity of at least a portion of the Joule heating element proximal to the reactor is in a range of 50-95%, inclusive.
Clause 27. The method of any clause or example herein, in particular, any one of Clauses 24-26, wherein the reactor is disposed at a distance of 1 millimeter or less from the Joule heating element.
Clause 28. The method of any clause or example herein, in particular, any one of Clauses 24-27, wherein the thickness of the reactor is at least two times of a thickness of the Joule heating element.
Clause 29. The method of any clause or example herein, in particular, any one of Clauses 24-28 wherein a thickness of the Joule heating element is in a range of 1-3 millimeters, inclusive, and the thickness of the reactor is in a range of 2-8 millimeters, inclusive.
Clause 30. The method of any clause or example herein, in particular, any one of Clauses 18-29, wherein the temperature gradient comprises a first temperature at the first end of the reactor that is greater than or equal to a melting temperature of the reactant.
Clause 31. The method of any clause or example herein, in particular, any one of Clauses 18-30, wherein, during one, some, or all of the processing cycles, the temperature gradient comprises a maximum temperature at a second end of the reactor opposite the first end that is greater than a decomposition temperature of the reactant.
Clause 32. The method of any clause or example herein, in particular, Clause 31, wherein the maximum temperature occurs at or near an end of the first period of the corresponding processing cycle.
Clause 33. The method of any clause or example herein, in particular, any one of Clauses 31-32, wherein a duration of the maximum temperature is less than a duration of the corresponding processing cycle.
Clause 34. The method of any clause or example herein, in particular, any one of Clauses 18-33, wherein, during one, some, or all of the processing cycles, the temperature gradient comprises a minimum temperature at a second end of the reactor opposite the first end that is less than a decomposition temperature of the reactant and greater than a first temperature at the first end of the reactor.
Clause 35. The method of any clause or example herein, in particular, Clause 34, wherein the minimum temperature is at or near an end of the second period of the corresponding processing cycle.
Clause 36. The method of any clause or example herein, in particular, any one of Clauses 18-35, wherein the one or more first products are produced at and/or carried from a second end of the reactor opposite the first end.
Clause 37. The method of any clause or example herein, in particular, Clause 36, wherein the one or more first products are conveyed from the reactor by a carrier gas.
Clause 38. The method of any clause or example herein, in particular, any one of Clauses 18-37, wherein the subjecting is such that the one or more first products are vaporized at a second end of the reactor opposite to the first end, while one or more second products formed from the reactant are retained within the reactor, the one or more second products being heavier than the one or more first products.
Clause 39. The method of any clause or example herein, in particular, Clause 38, wherein at least one of the one or more first products comprises a monomer, and at least one of the one or more second products comprises an oligomer.
Clause 40. The method of any clause or example herein, in particular, any one of Clauses 1-17, wherein the reactant is disposed in a container, and the heating during each first period is provided by a heating element in thermal contact with the container.
Clause 41. The method of any clause or example herein, in particular, any one of Clauses 1-17, wherein the heating during each first period is provided by a heating element, and the reactant is disposed on an external surface of the heating element.
Clause 42. The method of any clause or example herein, in particular, any one of Clauses 1-17, wherein:
   during the multiple processing cycles, the reactant is maintained in a melted state;
   the heating during each first period is provided by a heating element; and
   at least a portion of the heating element is disposed within the melted reactant.
Clause 43. The method of any clause or example herein, in particular, any one of Clauses 1-17, wherein the heating during each first period is provided by a heating element, and the reactant is embedded within the heating element.
Clause 44. The method of any clause or example herein, in particular, any one of Clauses 40-43, wherein the heating element is a Joule heating element.
Clause 45. The method of any clause or example herein, in particular, any one of Clauses 40-44, further comprising, prior to the subjecting:
   melting the reactant; and
   infiltrating the melted reactant into pores of the heating element such that the reactant becomes embedded into the heating element.
Clause 46. The method of any clause or example herein, in particular, any one of Clauses 1-45, wherein at least one of the one or more first products comprises a constituent monomer.
Clause 47. The method of any clause or example herein, in particular, any one of Clauses 1-46, wherein at least one of the one or more first products comprises a volatile or gas-phase species at a temperature greater than or equal to 300° C., for example, greater than 350° C.
Clause 48. The method of any clause or example herein, in particular, any one of Clauses 1-47, wherein at least one of the one or more first products has a carbon number less than or equal to 20.
Clause 49. A system for performing the method of any clause or example herein, in particular, any one of Clauses 1-48, the system comprising:
   a heating system; and
   a controller operatively coupled to the heating system, the controller comprising one or more processors and computer-readable storage media storing instructions that, when executed by the one or more processors, cause the controller to control the heating system to subject the reactant to the multiple consecutive processing cycles.
Clause 50. A system for processing a reactant, the reactant comprising one or more polymers, the system comprising:
   a reactor comprising a plurality of pores, a plurality of microchannels, or both;
   a heating system configured to heat at least the reactor; and
   a controller operatively coupled to the heating system, the controller comprising one or more processors and computer-readable storage media storing instructions that, when executed by the one or more processors, cause the controller to control the heating system to subject the reactant to multiple consecutive processing cycles, each processing cycle comprising a first period with heating applied and a second period immediately following the first period with no heating applied,
   wherein a duration of each processing cycle is less than or equal to 10 seconds,
   a duration of each first period is less than 1 second,
   the reactor is constructed to transport melted reactant at a first end of the reactor into the reactor via capillary action, and
   one or more of the processing cycles are effective to convert at least some of the reactant into one or more first products at a second end of the reactor opposite the first end.
Clause 51. The system of any clause or example herein, in particular, any one of Clauses 49-50, wherein the heating system comprises a Joule heating system, a microwave heating system, a laser heating system, an electron beam heating system, a spark discharge heating system, a solar heating system, a plasma heating system, or any combination of the foregoing.
Clause 52. The system of any clause or example herein, in particular, any one of Clauses 49-51, wherein the duration of each processing cycle is less than or equal to 1.5 seconds.
Clause 53. The system of any clause or example herein, in particular, any one of Clauses 49-52, wherein, for one, some, or all of the processing cycles, a duration of the first period is less than a duration of the second period of the corresponding processing cycle.
Clause 54. The system of any clause or example herein, in particular, any one of Clauses 49-53, wherein, for one, some, or all of the processing cycles, a duration of the first period is less than or equal to 10% of a duration of the second period of the corresponding processing cycle.
Clause 55. The system of any clause or example herein, in particular, any one of Clauses 49-54, wherein, for one, some, or all of the processing cycles, a duration of the first period is in a range of 10-500 milliseconds, inclusive.
Clause 56. The system of any clause or example herein, in particular, any one of Clauses 49-55, wherein the reactor comprises one or more layers formed of carbon, ceramic, metal, or combinations of the foregoing.
Clause 57. The system of any clause or example herein, in particular, any one of Clauses 49-56, wherein the reactor is disposed with respect to the heating system such that, during the multiple processing cycles, a temperature gradient is induced across a thickness of the reactor.
Clause 58. The system of any clause or example herein, in particular, any one of Clauses 49-57, wherein a thickness of the reactor is in a range of 2-8 millimeters, inclusive.
Clause 59. The system of any clause or example herein, in particular, any one of Clauses 49-58, wherein a porosity of at least a portion of the reactor at the first end is at least 40%.
Clause 60. The system of any clause or example herein, in particular, any one of Clauses 49-59, wherein a porosity of at least a portion of the reactor at the first end is in a range of 50-95%, inclusive.
Clause 61. The system of any clause or example herein, in particular, any one of Clauses 49-60, wherein the heating system comprises a Joule heating element, and the reactor is disposed in contact with or adjacent to the Joule heating element.
Clause 62. The system of any clause or example herein, in particular, Clause 61, wherein a porosity of at least a portion of the Joule heating element proximal to the reactor is at least 40%.
Clause 63. The system of any clause or example herein, in particular, any one of Clauses 61-62, wherein a porosity of at least a portion of the Joule heating element is in a range of 50-95%, inclusive.
Clause 64. The system of any clause or example herein, in particular, any one of Clauses 61-63, wherein a gap between the Joule heating element and the reactor is less than or equal to 1 millimeter.
Clause 65. The system of any clause or example herein, in particular, any one of Clauses 61-64, wherein a thickness of the reactor is at least two times of a thickness of the Joule heating element.
Clause 66. The system of any clause or example herein, in particular, any one of Clauses 61-65, wherein a thickness of the Joule heating element is in a range of 1-3 millimeters, inclusive, and a thickness of the reactor is in a range of 2-8 millimeters, inclusive.
Clause 67. The system of any clause or example herein, in particular, any one of Clauses 49-66, wherein:
   the reactor is disposed with respect to the heating system such that, during the multiple processing cycles, a temperature gradient is induced across a thickness of the reactor; and
   the computer-readable storage media stores instructions that, when executed by the one or more processors, cause the controller to control the heating system such that, during at least one of the processing cycles, the temperature gradient comprises a maximum temperature at the second end of the reactor that is greater than a decomposition temperature of the reactant.
Clause 68. The system of any clause or example herein, in particular, any one of Clauses 49-67, wherein the computer-readable storage media stores instructions that, when executed by the one or more processors, cause the controller to control the heating system such that, during at least one of the processing cycles, a duration of the maximum temperature is less than a duration of the corresponding processing cycle.
Clause 69. The system of any clause or example herein, in particular, any one of Clauses 49-68, wherein:
   the reactor is disposed with respect to the heating system such that, during the multiple processing cycles, a temperature gradient is induced across a thickness of the reactor; and
   the computer-readable storage media stores instructions that, when executed by the one or more processors, cause the controller to control the heating system such that, the temperature gradient comprises a minimum temperature at a second end of the reactor that is less than a decomposition temperature of the reactant and greater than a first temperature at the first end of the reactor.
Clause 70. The system of any clause or example herein, in particular, any one of Clauses 49-69, further comprising a capture device configured to collect and/or transport vaporized first products from the second end of the reactor.
Clause 71. The system of any clause or example herein, in particular, any one of Clauses 49-70, wherein at least one of the one or more first products comprises (a) a constituent monomer, (b) a volatile or gas-phase species at a temperature greater than or equal to 300° C., for example, greater than or equal to 350° C., (c) a product having a carbon number less than or equal to 20, or any combination of (a)-(c).

### CONCLUSION

Any of the features illustrated or described herein, for example, with respect to FIGS. 1A-12 and Clauses 1-71, can be combined with any other feature illustrated or described herein, for example, with respect to FIGS. 1A-12 and Clauses 1-71 to provide materials, systems, devices, structures, methods, and/or embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A method comprising:
subjecting a reactant to multiple consecutive processing cycles, each processing cycle comprising a first period with heating applied and a second period immediately following the first period with no heating applied, a duration of each processing cycle being less than or equal to 10 seconds, a duration of each first period being less than 1 second,
wherein the reactant comprises one or more polymers,
at least a first end of a reactor is disposed in contact with the reactant prior to the subjecting,
the reactor comprises a plurality of pores, a plurality of microchannels, or both,
the subjecting is such that a temperature gradient is induced across a thickness of the reactor,
during the subjecting, melted reactant is transported into the reactor via capillary action, and
the subjecting is effective to convert at least some of the reactant into one or more first products.

2. The method of claim 1, wherein at least one of the one or more first products comprises a constituent monomer.

3. The method of claim 1, wherein at least one of the one or more first products comprises a volatile or gas-phase species at a temperature greater than or equal to 350° C.

4-7. (canceled)

8. The method of claim 1, wherein the one or more polymers comprise a plastic or rubber having a carbon-carbon (C—C) backbone.

9. (canceled)

10. The method of claim 1, wherein the one or more polymers comprise a plastic having a carbon-noncarbon (C—X) backbone.

11. (canceled)

12. The method of claim 1, wherein the one or more polymers comprise a biomass selected from lignin, cellulose, rosin, chitin, chitosan, or any combination of the foregoing.

13. (canceled)

14. The method of claim 2, wherein the subjecting is such that a yield of the constituent monomer is at least 25 wt %.

15-18. (canceled)

19. The method of claim 1, wherein, for one, some, or all of the processing cycles, a duration of the first period is in a range of 10-500 milliseconds, inclusive.

20. The method of claim 1, wherein the subjecting is such that a selectivity for one or more constituent monomers is at least 10%.

21-25. (canceled)

26. The method of claim 1, wherein the heating during each first period is provided by a Joule heating element, and the reactor is disposed in contact with or adjacent to the Joule heating element.

27-31. (canceled)

32. The method of claim 1, wherein the temperature gradient comprises a first temperature at the first end of the reactor that is greater than or equal to a melting temperature of the reactant.

33. The method of claim 1, wherein, during at least one of the processing cycles, the temperature gradient comprises a maximum temperature at a second end of the reactor opposite the first end that is greater than a decomposition temperature of the reactant.

34-35. (canceled)

36. The method of claim 1, wherein, during at least one of the processing cycles, the temperature gradient comprises a minimum temperature at a second end of the reactor opposite the first end that is less than a decomposition temperature of the reactant and greater than a first temperature at the first end of the reactor.

37-39. (canceled)

40. The method of claim 1, wherein the subjecting is such that the one or more first products are vaporized at a second end of the reactor opposite to the first end, while one or more second products formed from the reactant are retained within the reactor, the one or more second products being heavier than the one or more first products.

41-43. (canceled)

44. A system for processing a reactant, the reactant comprising one or more polymers, the system comprising:
a reactor comprising a plurality of pores, a plurality of microchannels, or both;
a heating system configured to heat at least the reactor; and
a controller operatively coupled to the heating system, the controller comprising one or more processors and computer-readable storage media storing instructions that, when executed by the one or more processors, cause the controller to control the heating system to subject the reactant to multiple consecutive processing cycles, each processing cycle comprising a first period with heating applied and a second period immediately following the first period with no heating applied,
wherein a duration of each processing cycle is less than or equal to 10 seconds,
a duration of each first period is less than 1 second,
the reactor is constructed to transport melted reactant at a first end of the reactor into the reactor via capillary action, and
one or more of the processing cycles are effective to convert at least some of the reactant into one or more first products at a second end of the reactor opposite the first end.

45-50. (canceled)

51. The system of claim 44, wherein the reactor is disposed with respect to the heating system such that, during the multiple processing cycles, a temperature gradient is induced across a thickness of the reactor.

52. The system of claim 51, wherein a thickness of the reactor is in a range of 2-8 millimeters, inclusive.

53. The system of claim 44, wherein a porosity of at least a portion of the reactor at the first end is at least 40%.

54. (canceled)

55. The system of claim 44, wherein the heating system comprises a Joule heating element, and the reactor is disposed in contact with or adjacent to the Joule heating element.

56-59. (canceled)

60. The system of claim 55, wherein a thickness of the Joule heating element is in a range of 1-3 millimeters, inclusive, and a thickness of the reactor is in a range of 2-8 millimeters, inclusive.

61-65. (canceled)
